(19) United States
(12) Patent Application Publication
(10) Pub. No.: US 2007/0106035 A1
(43) Pub. Date: May 10, 2007

(54) Aromatic di-acid-containing poly (ester amide) polymers and methods of use

(75) Inventors: Zaza D. Gomurashvili, La Jolla, CA (US); Turner Daniel Jenkins, San Diego, CA (US); William Turnell, San Diego, CA (US); Ramaz Katsarava, Tbilisi, GA (US)

Correspondence Address: DLA PIPER US LLP, 4365 EXECUTIVE DRIVE, SUITE 1100, SAN DIEGO, CA, 92121-2133, US

(73) Assignee: MediVas, LLC, San Diego, CA (US)

(21) Appl. No.: 11/586,924

(22) Filed: Oct. 25, 2006

Related U.S. Application Data
(60) Provisional application No. 60/730,611, filed on Oct. 26, 2005.
(60) Provisional application No. 60/738,335, filed on Nov. 18, 2005.
(60) Provisional application No. 60/839,867, filed on Aug. 23, 2006.

(51) Int. Cl. C08F 283/04

(52) U.S. Cl. 525/426

(57) ABSTRACT

The present invention provides biodegrable, biocompatible aromatic di-acid-containing poly(ester amide) (PEA) polymers with thermo-mechanical properties that can be readily tailored by selection of various combinations and proportions of the di-acid residues in the polymers. The polymers are suitable for use in production of drug-releasing biodegradable particles and implantable surgical devices, such as stents and internal fixation devices. The polymer compositions and surgical devices biodegrade in vivo by enzymatic action to release bioactive agents in a controlled manner over time as well as biocompatible breakdown products, including one to multiple different amino acids.

### RELATED APPLICATIONS

This application relies for priority under 35 U.S.C. § 119(e) on U.S. provisional applications 60/730,611, filed Oct. 26, 2005, and 60/738,335, filed Nov. 18, 2005, and 60/839,867, filed Aug. 23, 2006.

### FIELD OF THE INVENTION

The invention relates, in general, to drug delivery systems and, in particular, to polymer delivery compositions that incorporate aliphatic amino acids into a biodegradable polymer backbone.

### BACKGROUND INFORMATION

The earliest drug delivery systems, first introduced in the 1970s, were based on polymers formed from lactic and glycolic acids. Today, polymeric materials still provide the most important avenues for research, primarily because of their ease of processing and the ability of researchers to readily control their chemical and physical properties via molecular synthesis. Basically, two broad categories of polymer systems, both known as “microspheres” because of their size and shape, have been studied: reservoir devices and matrix devices. The former involves the encapsulation of a pharmaceutical product within a polymer shell, whereas the latter describes a system in which a drug is physically entrapped within a polymer network.

The release of medications from either category of polymer device traditionally has been diffusion-controlled. Currently, however, modem research is aimed at investigating biodegradable polymer systems. These drug deliverers, for example polyhydoxyalkanoates, degrade into biologically acceptable compounds, often through the process of hydrolysis, and leave their incorporated medications behind. This erosion process occurs either in bulk (wherein the matrix degrades uniformly) or at the polymer's surface (whereby release rates are related to the polymer's surface area). The degradation process itself involves the breakdown of these polymers into lactic and glycolic acids. These acids are eventually reduced by the Kreb's cycle to carbon dioxide and water, which the body can easily expel.

Amino Acid based Bioanalogous Biopolymers (AABB)—a new family of hydrophobic α-amino acid based polymers recently has been developed. Poly(ester amides), (PEAs), poly(ester urethanes) (PEURs), and poly(ester ureas) (PEUs) with linear structures, which are based on α-amino acids, fatty dicarboxylic acids and aliphatic diols have been synthesized via an Active Polycondensation (APC) method. The APC method mainly is conducted in solution under mild temperatures without use of any toxic catalyst. Using this method, a large variety of AABB polymers with a broad range of physical and thermo-mechanical properties and biodegradation profiles have been reported und studied. See review paper and references therein by R. Katsarava (Macromol. Symp. (2003) 199:419-429).

In particular, α-amino acid-based poly(ester amide) (PEA) and poly(ester urethane) (PEUR) polymers demonstrate enzyme-mediated surface degradation (G. Tsitlanadze, et al. J. Biomater. Sci. Polym. Edn. (2004) 15:1-24 and T. Kartvelishvili, at al. Macromol. Chem. Phys. (1997) 198: 1921-1932) and PEAs show a low inflammation profile (K. DeFife et al. Transcatheter Cardiovascular Therapeutics—TCT 2004 Conference. Poster presentation. Washington DC. (2004)). These properties make PEAs and PEURs excellent materials for a variety of different medical and pharmaceutical applications.

A. Conix in 1957 reported the synthesis of aromatic polyanhydrides with excellent film and fiber-forming properties and high melting temperatures (up to 267° C.) based on 1,3-bis(4-carboxyphenoxy)propane (CPP) (A. Conix, Makromol. Chem, 24, 76-78, (1957)). However, these polymers were unsuitable for use in textiles due to the hydrolytic instability of anhydride linkage. CPP as di-acid monomer was again revisited by R. Langer's team (A. J. Domb and R. L. Langer. J. Polym. Sci.. Part A: Polym. Chem. (1987) 25:3373-3386) in the mid 1980s, and erodible biocompatible copolyanhydrides based on CPP and aliphatic dicarboxylic acids were designed.

FDA-approved controlled-delivery polymer wafer—Gliadel® (Guilford Pharmaceutical Corp, Baltimore, Md.), is the combination of a copolyanhydride matrix consisting of CPP and sebacic acid (in 20 to 80 molar ratios,) in which the anticancer agent is physically admixed (W. Dang et al. J. Contr. Rel. (1996) 42:83-92). Hydrolytic degradation products of Gliadel® wafer (in addition to the anticancer agent) are ultimately the starting di-acids: sebacic acid and CPP. Clinical investigations of Gliadel implants in rabbit brains have shown limited toxicity, initial activity and fast excretion of decomposition products—the free acids (A. J. Domb et al. Biomaterials. (1995) 16:1069-1072).

More recently, CPP was disclosed as a monomer useful in preparation of bioabsorbable stents for vascular applications by “Advanced Cardiovascular Systems, Inc”, in patent WO 03/080147 A1, 2003 and polymer particles in co-pending provisional application Ser. No. 60/684,670, filed May 25, 2005.

Another aromatic biodegradable di-acid monomer based on trans-4-hydroxy-cinnamic acid has been recently described. The monomer with general name 4,4′-(alkanedioyldioxy) dicinnamic acid inherently contains two hydrolytically labile ester groups, and is expected to undergo specific (enzymatic) and nonspecific (chemical) hydrolysis (M Nagata, Y. Sato. Polymer. (2004) 45:87-93).

Despite these advances in the art, there is a need for more and better varieties of biocompatible polymer compositions and methods for delivering therapeutic molecules, such as drugs and other bioactive agents, at a controlled rate of therapeutic or palliative release, while affording enhanced thermo-mechanical and physical properties.

### SUMMARY OF THE INVENTION

The present invention is based on the discovery of new aromatic di-acid-containing poly(ester amide) (PEA) polymer compositions with significant improvement in thermo-mechanical properties. Bis(α-amino acid)-α,ω)-alkylene-diester is a type of diamine monomer, useful for active polycondensation (APC), and which inherently contains two aliphatic ester linkages. Such ester groups can be enzymatically recognized by various esterases, thus making the polymer biodegradable. Condensation of diamine monomers, for example, with activated di-acid esters, results in a PEA macromolecule with ester and amide linkages. Incorporation of α,ω-bis(4-carboxyphenoxy)alkane, 3,3′-(alkanedioyldioxy)dicinnamic acid or 4,4′-(alkanedioyldioxy)dicinnamic acid as the di-acid residue in at least one of the bis(α-amino acid)-based building blocks in the invention PEA polymers confers high glass transition temperature (Tg) on the polymer. In addition, the invention PEA polymer compositions optionally can include a second, C-protected adirectional amino acid-based monomer to introduce additional flexibility into the polymer.

Accordingly in one embodiment, the invention provides polymer compositions containing at least one or a blend of poly(ester amide) (PEA) polymers having a chemical formula described by general structural formula (I) 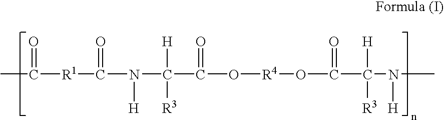
wherein, n is about 20 to about 150; each R¹ is independently selected from residues of α,ω-bis (o,m, orp-carboxyphenoxy)-(C₁-C₈) alkane, 3,3′-(alkenedioyldioxy)dicinnamic acid or 4,4′-(alkanedioyldioxy)dicinnamic acid; the R³s in each n monomer are independently selected from the group consisting of hydrogen, (C₁-C₆) alkyl, (C₂-C₆) alkenyl, (C₂-C₆) alkynyl, (C₆-C₁₀) aryl (C₁-C₆) alkyl and —(CH₂)₂S(CH₃); R⁴ is independently selected from the group consisting of (C₂-C₂₀) alkylene, (C₂-C₂₀) alkenylene, (C₂-C₈) alkyloxy, (C₂-C₂₀) alkylene, bicyclic-fragments of 1,4:3,6-dianhydrohexitols of general formula(II), and combinations thereof; 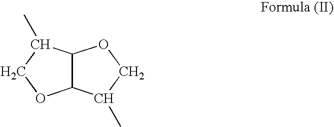
or a chemical structure described by general structural formula (III),

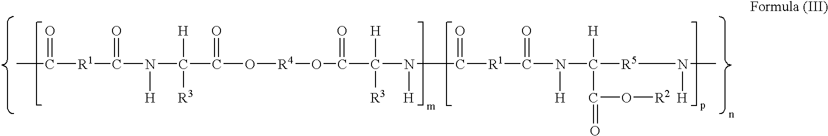

wherein m is about 0.1 to about 0.9; p is about 0.9 to about 0. 1, n is about 10 to about 150, R¹ is a combination of about 0.1 part to about 0.9 part of α,ω- bis(o,m orp-carboxy phenoxy)-(C₁-C₈) alkane, 3,3′-(alkenedioyldioxy)dicinnamic acid or 4,4′-(alkenedioyldioxy)dicinnamic acid and about 0.9 part to about 0.1 part selected from (C₂- C₂₀) alkylene, (C₂-C₂₀) alkenylene, or mixtures thereof; R² is hydrogen, or (C₆-C₁₀) aryl (C₁-C₆) alkyl or a protecting group; each R³ is independently hydrogen, (C₁-C₆) alkyl, (C₂-C₆) alkenyl, (C₂-C₆) alkynyl and (C₆-C₁₀) aryl (C₁-C₆) alkyl and —(CH₂)₂S(CH₃); each R⁴ is selected from the group consisting of (C₂-C₂₀) alkylene, (C₂-C₂₀) alkenylene, (C₂-C₈) alkyloxy (C₂-C₂₀) alkylene, bicyclic-fragments of 1,4:3,6-dianhydrohexitols of general formula III, and combinations thereof; and R⁵ is independently (C₁-C₂₀) alkyl or (C₂-C₂₀) alkenyl.

In another embodiment, the invention provides methods for fixing an internal body part in a subject by implanting into an internal body site a surgical internal fixation device fabricated using an invention polymer composition containing a α,ω)-bis(4-carboxyphenoxy) alkane, 3,3′-(alkenedioyldioxy)dicinnamic acid or 4,4′-(alkanedioyldioxy)dicinnamic acid-containing PEA polymer to fix the internal body site while the composition biodegrades to release substantially biocompatible break down products.

In yet another embodiment, the invention provides biodegradable, biocompatible surgical devices fabricated using an invention PEA polymer composition.

### A BRIEF DESCRIPTION OF THE FIGURES

FIG. 1 is a ¹H NMR (500 MHz, DMSO-d₆) spectrum of an invention PEA polymer containing 50% of CCP as the di-acid building block (polymer #3 in Table 1).

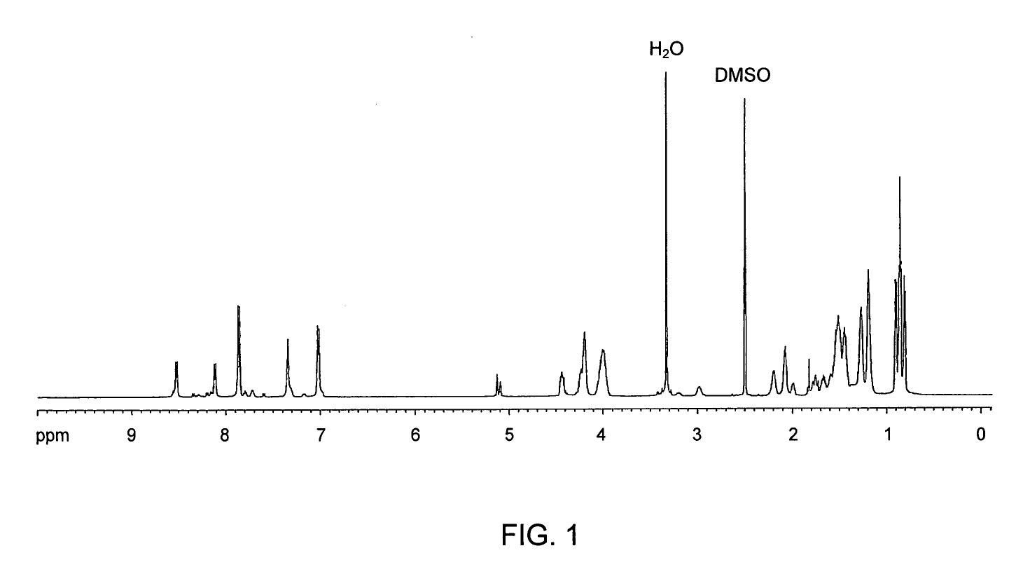

FIG. 2 is a graph showing a Differential Scanning Calorimetry trace of an invention PEA polymer (polymer #3 in Table 1), first heating, heating rate 10° C./min.

### A DETAILED DESCRIPTION OF THE INVENTION

The invention is based on the discovery that an active ester of an α,ω-bis(4-carboxyphenoxy)alkanoic di-acid is useful for active polycondensation and synthesis of copoly(ester amides) (PEAs) in which the α,ω-bis(o, m, or p-carboxyphenoxy) alkanoic acid is used to at least partially displace the aliphatic dicarboxylic acids used in fabrication. Such aromatic di-acid-containing PEA polymers have significant improvement in thermo-mechanical properties. While each of the building blocks contributes to the properties of any given PEA polymer, in the present invention selection of the di-acid residues in the bis-(α-amino acid)-diol-diester containing monomers is exploited to control the thermo-mechanical properties of the polymers. Incorporation of an aromatic residue, α,ω-bis(4-carboxyphenoxy)alkane, 3,3′-(alkenedioyldioxy)dicinnamic acid or 4,4′-(alkanedioyldioxy)dicinnamic acid, in the place of at least a portion of the aliphatic dicarboxylic acid residues in the diester-diamine based monomers confers relatively high glass transition temperature (Tg) on the polymer. The isomers 4,4′- and 3,3′-(alkanedioyldioxy)dicinnamic acid are newly discovered to be useful as di-acid monomer for PEA synthesis. Use of a residue of a saturated or unsaturated alkyl diol in the monomers provides elongation properties of the resulting polymer. A second, L-lysine-based monomer optionally can be included in an invention polymer to introduce an additional diol residue that can be selected to further control the thermo-mechanical properties of the polymer..

The biodegradable polymers containing unsaturated groups have potential for various applications. For example, unsaturated groups can be converted into other functional groups such as epoxy or alcohol—useful for further modifications. Their crosslinking could enhance thermal and mechanical properties of polymer. Cinnamate is known to undergo reversible [2+2] cycloaddition upon UV irradiation at wavelengths over 290 nm, without presence of photoinitiator, a property that makes the polymer self-photo-crosslinkable (Y. Nakayama, T. Matsuda. J. Polym. Sci. Part A: Polym. Chem. (1992) 30:2451-2457). In addition, the cinnamoyl group is metabolized in the body and has been proven to be non-toxic (Citations in paper of M Nagata, Y. Sato. Polymer (2004) 45:87-93).

The invention aromatic di-acid-containing PEA polymers exhibit a combination of hydrophobicity, relatively high glass transition temperature (Tg) to confer sufficient stiffness for the polymers to be extruded, and sufficient elongation properties to prevent brittleness. In certain embodiments, individual monomer units in the invention aromatic di-acid -containing PEA polymer compositions can be based on and break down during biodegradation to yield one of multiple different α-amino acids, as disclosed herein.

Like other PEA polymers, the invention aromatic di-acid-containing PEA polymer compositions can be used to deliver in vivo at least one bioactive agent that is dispersed in the polymer of the composition. The invention PEA polymer compositions biodegrade in vivo by enzymatic action so as to release the at least one bioactive agent(s) from the polymer in a controlled manner over time. Thus the invention provides new PEA polymers suitable for certain applications requiring a combination of hydrophobicity, relatively high glass transition temperature (Tg), and elongation or flexibility properties. Moreover, since theoretically the bis(α-amino acid)-diol-diester co-monomers in the invention PEA polymers may each contain a different one of the multiple amino acids disclosed herein in each bis(α-amino acid) building block, the invention PEA polymer compositions may break down to produce from one to multiple different of such α-amino acids.

More particularly, in one embodiment, the invention provides polymer compositions comprising a PEA polymer having a chemical formula described by general structural formula (I): 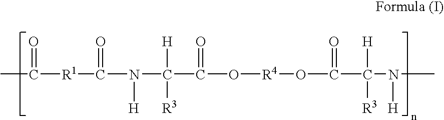
wherein, n is about 10 to about 150; each R¹ is independently selected from residues of α,ω-bis (o,m, orp-carboxyphenoxy) (C₁-C₈) alkane, 3,3′-(alkenedioyldioxy)dicinnamic acid or 4,4′-(alkanedioyldioxy)dicinnamic acid; the R³s in each n monomer are independently selected from the group consisting of hydrogen, (C₁-C₆) alkyl, (C₂-C₆) alkenyl, (C₂-C₆) alkynyl, (C₆-C₁₀) aryl (C₁-C₆) alkyl and —CH₂)₂S(CH₃); R⁴ in each n monomer is independently selected from the group consisting of (C₂-C₂₀) alkylene, (C₂-C₂₀) alkenylene, (C₂-C₈) alkyloxy, (C₂-C₂₀) alkylene, bicyclic-fragments of 1,4:3,6-dianhydrohexitols of general formula(II), and combinations thereof; 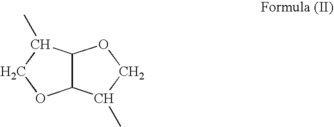
or a chemical structure described by general structural formula (III),

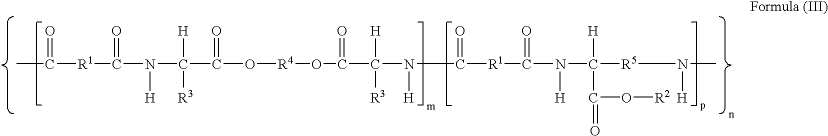

wherein m is about 0.1 to about 0.9; p is about 0.9 to about 0. 1, n is about 20 to about 150, R¹ is a combination of about 0.1 part to about 0.9 part of α,ω-bis-(o, m, or p-carboxyphenyloxy)-(C₁-C₈) alkane, 3,3′-(alkenedioyldioxy)dicinnamic acid or 4,4′-(alkanedioyldioxy)dicinnamic acid and about 0.9 part to about 0.1 part selected from (C₂- C₂₀) alkylene, (C₂-C₂₀) alkenylene, or mixtures thereof; R² is hydrogen, or (C₆-C₁₀) aryl (C₁-C₆) alkyl or a protecting group; each R³ is independently hydrogen, (C₁-C₆) alkyl, (C₂-C₆) alkenyl, (C₂-C₆) alkynyl and (C₆-C₁₀) aryl (C₁-C₆) alkyl and —(CH₂)₂S(CH₃); each R⁴ is selected from the group consisting of (C₂-C₂₀) alkylene, (C₂-C₂₀) alkenylene, (C₂-C₈) alkyloxy (C₂-C₂₀) alkylene, bicyclic-fragments of 1,4:3,6-dianhydrohexitols of general formula III, and combinations thereof; and R⁵is independently (C₁-C₂₀) alkyl or (C₂-C₂₀) alkenyl.

A typical protecting group is t-butyl, or others as are known in the art. The bicyclic-fragments of 1,4:3,6-dianhydrohexitols can be derived from “sugar alcohols”, such as D-glucitol, D-mannitol, or L-iditol, for example isosorbide (1,4:3,6-dianhydrosorbitol).

In one embodiment, the R³s are —CH₂)₃—, and the compound released by biodegradation of the polymer is an imino acid, analogous to pyrrolidine-2-carboxylic acid.

In certain embodiments, R⁵ is independently (C₃-C₆) alkyl or (C₃-C₆) alkenyl, for example —(CH₂)₄—.

The chemical formula of the class of α,ω-bis(o, m, or p-carboxyphenoxy) (C₁ to C₈) alkanoic di-acids useful in the practice of the invention is described by structural formula (IV) 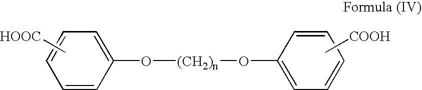
wherein, n=1 to 8.

Known examples of di-acids of α,ω-bis(4-carboxyphenoxy) (C₁-C₈) alkanes suitable for use in practice of the invention include CPP (1,3-bis(4-carboxyphenoxy)propane) (n=3), (Compound 1), which has the following formula: 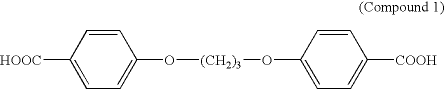
A second known α,ω-bis(4-carboxyphenoxy) (C₁-C₈) alkanoic di-acid is (1,6-bis (4-carboxyphenoxy) hexane) CPH (Formula (IV), n=6). This compound has been reported to be a useful monomer for biodegradable implants (M. J. Kipper et al. Biomaterials (2002) 23:4405-4412). However, use of di-esters of CPH in preparation of the invention polymers generates a PEA polymer with lower Tg and strength measurements at failure than does CPP. Potentially promising third compound of this group of di-acids is bis(4-carboxyphenoxy)methane, (Formula (IV), n=1), reported recently as useful di-acid for biodegradable co-poly(anhydrides) synthesis. (J. P. Jain et al. J. Controlled. Release. (2005) 103: 541-563

The chemical formula of the 4-hydroxycinnamic acid based di-acids, with general name 4,4′-(α,ω-alkanedioyldioxy) dicinnamic acid, useful in the practice of the invention is described by structural formula (V) 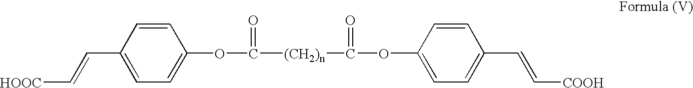
wherein, n=2 to 12;

Known examples of di-acids of 4,4′-(α,ω-alkanedioyldioxy)dicinnamic acid group, suitable for use in practice of the invention include 4,4′-(adipoyldioxy)dicinnamic acid, which has the following formula (compound 2), (M Nagata, Y. Sato. Polymer. (2004) 45: 87-93)

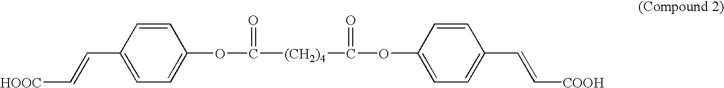

The chemical formula of the 3-hydroxycinnamic acid based di-acids, with general name 3,3′-(α,ω-alkanedioyldioxy)dicinnamic acid, useful in the practice of the invention, is described by structural formula (VI). 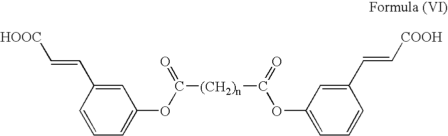
wherein, n=2 to 12

For example, Compound 3 described here is 3,3′-(adipoyldioxy)dicinnamic acid, 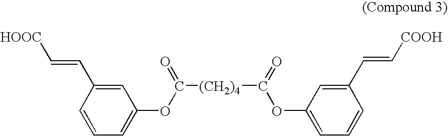
The meta-isomers introduce more disorder in polymer chain packing than the para-isomers. Therefore, monomers and polymers containing the compounds of Formula VI are expected to be more soluble in the reaction mixture and polymerization requires lower temperature. This combination of properties contributes to formation of higher molecular weight polymers than when the para-isomers are used.

The n monomers in the invention PEA polymers of structure (I) can be identical, in which case the polymer is referred to herein as a “homo-polymer.” Alternatively the n repeat unit in the invention PEA polymers of structure (I) can be different, being fabricated using different combinations of building blocks (i.e., diols, di-acids and α-amino acids), in which case the polymer is referred to herein as a “co-polymer”. The m-repeat unit in the invention PEA polymers of structure (III), which include an L-lysine-based p-repeat unit can be either identical or different.

As used herein, the term “residue of a di-acid” means a portion of a dicarboxylic-acid, as described herein, that excludes the two carboxyl groups of the di-acid. As used herein, the term “residue of a diol” means a portion of a diol, as described herein, which excludes the two hydroxyl groups of the diol. The corresponding di-acid or diol containing the “residue” thereof is used in synthesis of the co-polymer compositions. The residue of the di-acid or diol is reconstituted in vivo (or under similar conditions of pH, aqueous media, and the like) to the corresponding diol or di-acid upon release from the polymer composition by biodegradation in a controlled manner that depends upon the properties of the α,ω-bis (o, m, or p-carboxyphenoxy) alkane-containing polymer used in the composition, which properties are as described herein, for example in the Examples.

As used herein, the terms “α-amino acid-containing”, and “α-amino acid” mean a chemical compound containing an amino group, a carboxyl group and R³ groups as defined herein. As used herein, the terms “biological α-amino acid-containing” and “biological amino acid” mean the α-amino acid(s) used in synthesis are naturally occurring L-phenylalanine, leucine, glycine, alanine, valine, isoleucine, lysine, or methionine, or a mixture thereof. Additional adirectional biological amino acids used in fabrication of invention co-polymers may include lysine and ornithine, but are oriented in the co-polymer backbone adirectionally (i.e., in a non-biological orientation) such that the carboxyl group of the amino acid (which may also be substituted by an R² other than H) is pendent rather than being incorporated into a peptide bond. Additional adirectional amino acids can be incorporated into the invention compositions by varying the R⁵ group as described herein.

As used herein the term “bioactive agent” means a bioactive agent as disclosed herein that is not incorporated into the polymer backbone, but is dispersed within the PEA polymer in the invention composition. One or more such bioactive agents may optionally be included in the invention polymer compositions. As used herein to refer to the bioactive agent(s), the term “dispersed” means the bioactive agents are intermixed or dissolved in, homogenized with, and/or covalently bound or conjugated to a PEA polymer in invention an invention composition, for example attached to a functional group in the PEA polymer of the composition or to the surface of a polymer particle or surgical device made using the invention polymer composition.

The term, “biodegradable, biocompatible” as used herein to describe the invention PEA polymer compositions means the polymer is capable of being broken down into innocuous products in the normal functioning of the body. This is particularly true when the amino acids used in fabrication of the PEA polymers are biological L-α-amino acids. These PEA polymer compositions include hydrolyzable ester and enzymatically cleavable amide linkages that provide biodegradability, and are typically chain terminated, predominantly with amino groups. Optionally, the amino termini of the polymers can be acetylated or otherwise capped by conjugation to any other acid-containing, biocompatible molecule, to include without restriction organic acids, bioinactive biologics, other polymers and bioactive agents as described herein. In one embodiment, the entire polymer composition, and any particles, or surgical device made thereof, is substantially biodegradable.

In one alternative, at least one of the α-amino acids used in fabrication of the invention polymers is a biological α-amino acid. For example, when the R³s are CH₂Ph, the biological α-amino acid used in synthesis is L-phenylalanine. In alternatives wherein the R³s are CH₂—CH(CH₃)₂, the polymer contains the biological α-amino acid, L-leucine. By varying the R³s within co-monomers as described herein, other biological α-amino acids can also be used, e.g., glycine (when the R³s are H), alanine (when the R³s are CH₃), valine (when the R³s are CH(CH₃)₂), isoleucine (when the R³s are CH(CH₃)CH₂CH₃), phenylalanine (when the R³s are CH₂—C₆H₅),, or methionine (when the R³s are —(CH₂)₂SCH₃, and mixtures thereof. When the R³s are —(CH₂)₃— (as 2-pyrrolidinecarboxylic acid), a α-amino acid can be used. In yet another alternative embodiment, all of the various α-amino acids contained in the invention aromatic di-acid-containing PEA polymers are biological α-amino acids, as described herein.

The term “aryl” is used with reference to structural formulas herein to denote a phenyl radical or an ortho-fused bicyclic carbocyclic radical having about nine to ten ring atoms in which at least one ring is aromatic. In certain embodiments, one or more of the ring atoms can be substituted with one or more of nitro, cyano, halo, trifluoromethyl, or trifluoromethoxy. Examples of aryl include, but are not limited to, phenyl, naphthyl, and nitrophenyl.

The term “alkenylene” is used with reference to structural formulas herein to mean a divalent branched or unbranched hydrocarbon chain containing at least one unsaturated bond in the main chain or in a side chain.

In addition, the polymer molecules may optionally have a bioactive agent conjugated thereto via a linker or incorporated into a crosslinker between molecules.

Further, the aromatic di-acid-containing PEA polymer compositions suitable for use in the practice of the invention bear functionalities that allow the option of covalent attachment of bioactive agent(s) to the polymer. For example, a polymer bearing free carboxyl groups can readily react with an amino moiety, thereby covalently bonding a peptide to the polymer via the resulting amide group. As will be described herein, the biodegradable polymer and a bioactive agent may contain numerous complementary functional groups that can be used to covalently attach the bioactive agent to the biodegradable polymer.

Further examples of PEA polymers related to those contemplated for use in the practice of the invention and methods of synthesis include those set forth in U.S. Pat. Nos. 5,516, 881; 5,610,241; 6,476,204; and 6,503,538; and in U.S. application Ser. Nos. 10/096,435; 10/101,408; 10/143,572; 10/194,965 and 10/362,848.

In certain embodiments, particles or a surgical device made from or containing the invention aromatic di-acid-containing PEA polymer composition, as described herein, plays an active role in the treatment processes at the site of implant or use by holding the polymer and any bioactive agents dispersed therein at the site for a period of time sufficient to allow the subject's endogenous processes to slowly release particles or polymer molecules from the composition. Meanwhile, the subject's endogenous processes biodegrade the polymer so as to release bioactive agents dispersed in the polymer. The fragile optional bioactive agents are protected by the more slowly biodegrading polymer to increase half-life and persistence of the bioactive agent(s) locally at the site of use, e.g., implant. A detailed description of methods of making polymer particles using related PEA polymers may be found in co-pending U.S. application Ser. No. 11/344,689, filed Jan. 31, 2006.

In addition, the invention PEA polymers disclosed herein (e.g., those having structural formulae (I, and II)), upon enzymatic degradation, provide α-amino acids, such as biological α-amino acids, and other breakdown products that can be readily metabolized. When biodegradation products are sparingly water-soluble di-acid monomers, elimination proceeds via solubilization in a biological environment as a slow process. The aliphatic di-acid sebacic acid will most likely participate in the β-oxidation pathway, yielding acetic-coA, which could be used in a typical biosynthetic pathway. Aromatic di-acids, such as CPP, are eliminated without further metabolic transformation. (D. S. Katti, et al. Adv. Drug deliv. Rev. (2002).54(7): 933-961). Uptake of the polymer with bioactive agent is safe: studies have shown that the subject can metabolize/clear the polymer degradation products. The invention PEA polymer compositions are, therefore, substantially non-inflammatory to the subject both at the site of implant and systemically, apart from any trauma caused by implantation itself.

The invention PEA polymers and compositions preferably have weight average molecular weights ranging from 15,000 to 600,000 Daltons; these polymers typically have inherent viscosities at 25° C., determined by standard viscosimetric methods, ranging from 0.3 to 3.5, preferably ranging from 0.4 to 2.0

The molecular weights and polydispersities herein are determined by gel permeation chromatography (GPC) using polystyrene standards. More particularly, number and weight average molecular weights (Mₙ and M_{w}) are determined, for example, using a Model 510 gel permeation chromatographer (Water Associates, Inc., Milford, Mass.) equipped with a high-pressure liquid chromatographic pump, a Waters 486 UV detector and a Waters 2410 differential refractive index detector. Solution of 0.1% LiCl in N, N-dimethylacetamide (DMAc) is used as the eluent (1.0 mL/min). The polystyrene (PS) standards, which have a narrow molecular weight distribution, were used for calibration of GPC curves.

Methods for making PEA polymers containing α-amino acids in the general formula are well known in the art. For example, for the embodiment of the polymer of formula (I), a α-amino acid can be converted into a bis(α-amino acid)-diol-diester monomer, for example, by condensing the α-amino acid with a diol as described herein. As a result, ester bonds are formed. Then, the bis(α-amino acid)-diol-diester is entered into a polycondensation reaction with a di-acid, such as sebacic acid, or α,ω-bis(4-carboxyphenoxy) alkanoic di-acid, to obtain the final polymer having both ester and amide bonds. Alternatively, instead of the di-acid, an activated di-acid derivative, e.g., di-(p-nitrophenyl) ester, can be used for polymers of chemical structure (I) or (III).

More particularly, synthesis of the unsaturated poly(ester-amide)s (UPEAs) useful as polymers of the structure (I) or (III) as described above will be described wherein

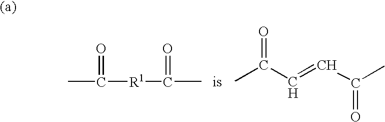

for example, and/or (b) R³ is —CH₂—CH═CH—CH₂—. In cases where (a) is present and (b) is not present, R³ is —C₄H₈— or —C₆H₁₂—. In cases where (a) is not present and (b) is present, R¹ is —C₄H₈— or —C₈H₁₆—.

The UPEAs can be prepared by solution polycondensation of either (1) di-p-toluene sulfonic acid salt of bis(α-amino acid) diesters, comprising at least 1 double bond in the diol residue, a di-p-toluene sulfonic acid salt of a bis(α-amino acid)-alkylene-diesters, comprising a diol of structural formula (II), and di-p-nitrophenyl esters of saturated dicarboxylic acid or (2) two di-p-toluene sulfonic acid salt of bis(α-amino acid) alkylene-diesters, comprising no double bonds in the diol residues, and di-p-nitrophenyl ester of unsaturated dicarboxylic acid or (3) two di-p-toluene sulfonic acid salts of bis (α-amino acid)-diol-diesters, comprising at least one double bond in one of the diol residues in the polymer general structural formula, the other diol residue having structural formula (II), and di-nitrophenyl esters of unsaturated dicarboxylic acids.

Salts of p-toluene sulfonic acid are known for use in synthesizing polymers containing amino acid residues. The aryl sulfonic acid salts are used instead of the free base because the aryl sulfonic salts of bis(α-amino acid)-alkylene-diesters are easily purified through recrystallization and render the amino groups as stable ammonium tosylates throughout workup. In the polycondensation reaction, the nucleophilic amino group is readily revealed through the addition of an organic base, such as triethylamine, so the polymer product is obtained in high yield.

For unsaturated polymers of structure (I or II), the di-p-nitrophenyl esters of unsaturated dicarboxylic acid can be synthesized from p-nitrophenol and unsaturated dicarboxylic acid chloride, e.g., by dissolving triethylamine and p-nitrophenol in acetone and adding unsaturated dicarboxylic acid chloride dropwise with stirring at below −65° C. and pouring into water to precipitate product. Suitable acid chlorides included fumaric, maleic, mesaconic, citraconic, glutaconic, itaconic, ethenyl-butane dioic and 2-propenyl-butanedioic acid chlorides.

The di-aryl sulfonic acid salts of bis(α-amino acid)-diesters of saturated and unsaturated diols can be prepared by admixing α-amino acid, aryl sulfonic acid (e.g., p-toluene sulfonic acid monohydrate) and saturated or unsaturated diol in toluene, heating to reflux temperature, until water evolution is minimal, then cooling. The unsaturated diols include, for example, 2-butene-1,4-diol and 1,18-octadec-9-en-diol.

Saturated di-p-nitrophenyl esters of dicarboxylic acid and saturated di-p-toluene sulfonic acid salts of bis(α-amino acid)-alkylene-diesters can be prepared as described in U.S. Pat. No. 6,503,538 B1.

Although the invention PEA polymer compositions comprise poly(ester amides) (PEAs) made by polycondensation of components as described above, in the present invention, the components include a di-p-toluenesulfonic acid salt of bis(α-amino acid)-1,4:3,6-dianhydrosorbitol diester; a di-p-toluenesulfonic acid salt of bis(α-amino acid)-linear aliphatic α,ω-diol diester and a di-p-nitrophenyl ester of aliphatic (fatty) dicarboxylic acid. The di-p-nitrophenyl esters of dicarboxylic acids are used because the p-nitrophenyl ester is a very good leaving group that can promote the condensation reaction to move to the right of the reaction equation so the polymer product is obtained in high yield. In addition, the di-p-nitrophenyl esters are stable throughout workup and can be handled and dried in open atmosphere.

The di-aryl sulfonic acid salts of bis(α-amino acid) diol-diesters of unsaturated diols can be prepared by admixing α-amino acid, p-aryl sulfonic acid (e.g. p-toluene sulfonic acid monohydrate) and saturated or unsaturated diol in toluene, heating to reflux temperature, until water evolution is minimal, then cooling. The unsaturated diols include, for example, 2-butene-1,4-diol and 1,1 8-octadec-9-en-diol.

A working example of a diamine monomer having structural formula (III), in U.S. Pat. No. 6,503,538 is provided by substituting p-toluene sulfonic acid salt of bis(L-phenylalanine)-2-butene-1,4-diester for (III) in Example 1 of U.S. Pat. No. 6,503,538 or by substituting bis (p-nitrophenyl) fumarate for (V) in Example 1 of U.S. Pat. No. 6,503,538 or by substituting p-toluene sulfonic acid salt of bis(L-phenylalanine)-2-butene-1,4-diester for III in Example 1 of U.S. Pat. No. 6,503,538 and also substituting bis(p-nitrophenyl) fumarate for (V) in Example 1 of U.S. Pat. No. 6,503,538.

In unsaturated PEA, the following hold: Aminoxyl radical e.g., 4-amino TEMPO can be attached using carbonyldiimidazol, or suitable carbodiimide, as a condensing agent. Optionally, bioactive agents, as described herein, can be attached via a double bond functionality, preferably one that does not occur in a residue of a bioactive agent in the polymer backbone. Hydrophilicity, if desired, can be imparted by bonding to poly(ethylene glycol) mono- or diacrylate.
General methodfor Preparation of Di-p-nitrophenyl ester of CPP (Compound 4)

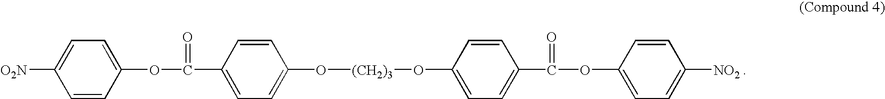

Preparation of this compound has been carried out by two different methods. In the direct condensation method CPP, condensation of CPP with p-nitrophenol is accomplished using thionyl chloride as condensing reagent. CPP, p-nitrophenol, and a few drops of DMF in dry chlorobenzene are added to thionyl chloride and heated to about 80° C. under slow nitrogen gas flow until the reaction mixture becomes homogenous. The cooled solution was diluted with hexanes and kept over night at 0° C. Separated yellow crystals collected by filtration, washed with hexane are re-crystallized from acetone.

Two step synthesis via acid chloride was also developed, as described in detail in Example 1 herein, using oxalyl chloride. Briefly, CPP and a few drops of pyridine are suspended dry chloroform. At room temperature, oxalyl chloride solution in dichloromethane is added and the solution is heated to reflux for about another 6 hours. After cooling, a clear reaction solution is filtered under exclusion of moisture and then diluted with hexanes. Yellow crystals separated from the filtrate were collected and dried under vacuum at room temperature. In a second step, to a chilled (0° C.) solution of p-nitrophenol and triethylamine in dry ethylacetate, a solution of CPP-dichloride in ethylacetate is added dropwise. Then, the solvent is evaporated, and solid product is washed, dried and recrystallized from acetone.

The description and methods of synthesis of related PEA polymers are set forth in U.S. Pat. Nos. 5,516, 881; 6,476,204; 6,503,538; and in U.S. application Ser. Nos. 10/096,435; 10/101,408; 10/143,572; 10/194,965; 10/362,848, 10/346,848, 10/788,747, the entire content of each of which is incorporated herein by reference.

The aromatic di-acid-containing PEA polymers described herein have weight average molecular weights ranging from 15,000 to 600,000 Daltons; these polymers and copolymers typically have inherent viscosities at 25° C., determined by standard viscosimetric methods, ranging from 0.3 to 4.0, preferably ranging from 0.4 to 2.0.

The aromatic di-acid-containing PEA polymers described herein can be fabricated in a variety of molecular weights and a variety of relative proportions of the two bis(α-amino acid)-alkylene-diester containing units and optional L-lysine based monomer. The appropriate molecular weight for a particular use is readily determined by one of skill in the art based on the guidelines contained herein and the thermo-mechanical properties disclosed. Thus, e.g., a suitable molecular weight will be on the order of about 15,000 to about 600,000 Daltons, for example about 15,000 to about 400,000, or about 15,000 to about 300,000.

The invention PEA polymers useful in the invention compositions, biodegradable surgical devices and methods of use biodegrade by enzymatic action at the surface. Therefore, the polymers, for example particles thereof, facilitate in vivo release of a bioactive agent dispersed in the polymer at a controlled release rate, which is specific and constant over a prolonged period. Additionally, since PEA polymers break down in vivo via enzymes without production of adverse side products, the polymers in the invention compositions and surgical devices, such as those that produce biological α-amino acids upon break down, are substantially non-inflammatory.

Synthesis of the unsaturated poly(ester-amide)s (UPEAs) useful as biodegradable polymers of the structure (I) as described above will now be described. Compounds having the structure (II) can be made in similar fashion to the compound (VII) of U.S. Pat. No. 6,503,538 B1, except that R⁴ of (III) of U.S. Pat. No. 6,503,538 and/or R¹ of (V) of U.S. Pat. No. 6,503,538 is (C₂-C₂₀) alkenylene as described above. Unsaturated copolymers, co-UPEAs containing different feed ratios of two diamine monomers R⁴ of (III) of U.S. Pat. No. 6,503,538 will have combinations of above described (C₂-C₂₀) alkenylene and residue of 1,4:3,6-dianhydrohexitols. And/or R¹ in (V) of U.S. Pat. No. 6,508,538 is (C₂-C₂₀) alkenlylene or combinations of alkenylene and fatty acid residues with various feed ratios. Reaction is carried out, for example, by adding dry triethylamine to a mixture of said (III) and (IV) of U.S. Pat. No. 6,503,538 and said (V) of U.S. Pat. No. 6,503,538 in dry N,N-dimethylacetamide, at room temperature, then increasing the temperature to 80° C. and stirring for 16 hours, then cooling the reaction solution to room temperature, diluting with ethanol, pouring into water, separating polymer, washing separated polymer with water, drying to about 30° C. under reduced pressure and then purifying up to negative test on p-nitrophenyl and p-toluene sulfonic acid. A preferred reactant (IV) of U.S. Pat. No. 6,503, 538 is p-toluene sulfonic acid salt of L-lysine benzyl ester, the benzyl ester protecting group is preferably removed from (I) to confer biodegradability, but it should not be removed by hydrogenolysis as in Example 22 of U.S. Pat. No. 6,503,538 because hydrogenolysis would saturate the desired double bonds; rather the benzyl ester group should be converted to an acid group by a method that would preserve unsaturation, e.g., by treatment with fluoroacetic acid or gaseous HF. Alternatively, the lysine reactant (IV) of U.S. Pat. No. 6,503, 538 can be protected by a protecting group different from benzyl which can be readily removed in the finished product while preserving unsatuiation, e.g., the lysine-based reactant can be protected with t-butyl (e.g., the reactant can be t-butyl ester of lysine) and the t-butyl can be converted to the “H” form (free carboxylic acid) while preserving unsaturation by treatment of the product (II) with acid.

In unsaturated compounds having structural formula (I) or (III), the following hold: An amino substituted aminoxyl (N-oxide) radical bearing group e.g., 4-amino TEMPO, can be attached using carbonyldiimidazole, or suitable carbodiimide, as a condensing agent. Bioactive agents, and the like, as described herein, optionally can be attached via the double bond functionality. Hydrophilicity can be imparted by bonding to poly(ethylene glycol) diacrylate.

Polymers contemplated for use in the practice of the invention can be synthesized by a variety of methods well known in the art. For example, tributyltin (IV) catalysts are commonly used to form polyesters such as poly(caprolactone), poly(glycolide), poly(lactide), and the like. However, it is understood that a wide variety of catalysts can be used to form polymers suitable for use in the practice of the invention.

Such poly(caprolactones) contemplated for use have an exemplary structural formula (VII) as follows:

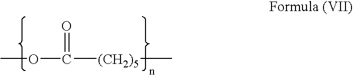

Poly(glycolides) contemplated for use have an exemplary structural formula (VIII) as follows:

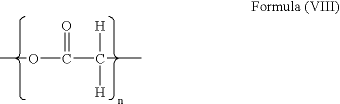

Poly(lactides) contemplated for use have an exemplary structural formula (IX) as follows:

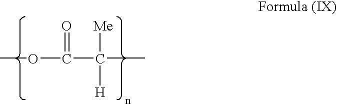

An exemplary synthesis of a suitable poly(lactide-co-ε-caprolactone) including an aminoxyl moiety is set forth as follows. The first step involves the copolymerization of lactide and ε-caprolactone in the presence of benzyl alcohol using stannous octoate as the catalyst to form a polymer of structural formula (X).

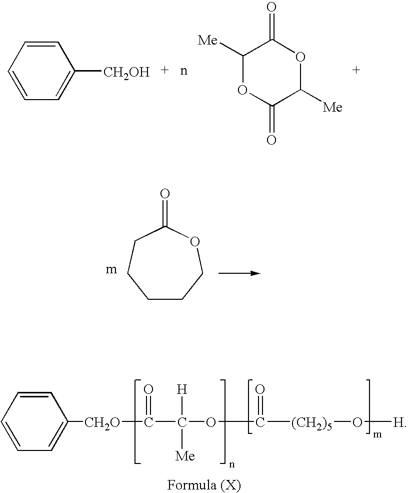

The hydroxy terminated polymer chains can then be capped with maleic anhydride to form polymer chains having structural formula (XI):

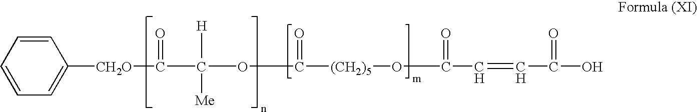

At this point, 4-amino-2,2,6,6-tetramethylpiperidine-1-oxy can be reacted with the carboxylic end group to covalently attach the aminoxyl moiety to the copolymer via the amide bond which results from the reaction between the 4-amino group and the carboxylic acid end group. Alternatively, the maleic acid capped copolymer can be grafted with polyacrylic acid to provide additional carboxylic acid moieties for subsequent attachment of further aminoxyl groups.

Due to the versatility of the aromatic di-acid-containing PEA polymers used in the invention compositions, the relative amounts of stiffness and elongation properties of the polymers can be controlled by varying the proportions of the two bis(α-amino acid)-containing, the lysine-based unit and other building blocks of the polymer. For example, Table 1 herein illustrates the differences in Tg, tensile stress at yield, percent elongation and Young's modulus of a film of PEA polymers of structural formula (I) and how relative proportions of the aliphatic di-acid to α,ω-bis (4-carboxyphenoxy) alkanoic-diacid, 3,3′-(alkenedioyldioxy)dicinnamic acid or 4,4′-(α,ω-alkanedioyldioxy)dicinnamic acid in the invention polymers affect the various properties. For example, Table 1 illustrates the mechanico-thermal characteristics and tensile properties of a 0.125 mm thick film of the invention PEA of Formula (III), (where R³ is CH₂—CH(CH₃)₂ L-Leucine, R² is CH₂-Ph and R⁴ is -(CH₂)₆- hexane diole,) containing various R¹ feed ratios of CPP to sebacic acid.

TABLE 1

| | | | | | | | Tensile Stress | | Young's |
|---|---|---|---|---|---|---|---|---|---|
| Polymer | CPP to sebacic | Yield | Tg^{a)} | Tm^{a)} | Mw^{b)} | | at Break | % | Modulus |
| # | acid feed ratio % | [%] | [° C.] | [° C.] | ×10⁻³ | PDI^{b)} | [MPa] | Elong | [MPa] |
| 1 | 25 | 78 | 35 | — | 64 | 1.56 | 40.4 | 327 | 1205 |
| 2 | 35 | 66 | 37 | 224 | 70 | 1.81 | 21.6 | 217 | 772 |
| 3 | 50 | 79 | 45.5 | 287 | 82 | 1.66 | 51.5 | 6.1 | 1309 |
| 4* | 50 | 52 | 73 | 232 | 69 | 1.58 | 24.4 | 6.3 | 672 |

*hexanediol in scheme is replaced with 50% (mol) isosorbide, (Compound 6).
DSC Measurements were taken from second heating, heating rate 10° C./min.
GPC Measurements were carried out in DMAc, (PS).

Further, as shown in polymer #4 in Table 1, replacement of a portion of aliphatic diol feed with a 1,4:3,6-dianhydrohexitol will further raise the glass transition temperature (Tg) of the polymer. In general, the invention aromatic di-acid-containing PEA polymers formed as described herein, for example, in the Examples herein, can be expected to have the following thermo-mechanical properties.

1. A glass transition temperature in the range from about 22° C. to about 120° C., for example, in the range from about 35° C. to about 80° C., from about 37° C. to about 73° C.;

2. A film of the polymer with an average thickness of about 0.125 mm will have a tensile stress at yield of about 25 MPa to about 90 MPa, for example, about 20 MPa to about 50 MPa, or about 21.6 MPa to about 51.5 MPa;

3. A film of the polymer with an average thickness of about 0.125 mm will have a percent elongation of about 2% to about 400%, for example about 5% to about 350% or about 6.1% to about 327%; and

4. A film of the polymer with an average thickness of about 0.125 mm will have a Young's modulus in the range from about 400 MPa to about 2000 MPa, for example about 500 MPa to about 2000 MPa, or about 672 MPa to about 1309 MPa.

Thus, by judicious choice of the content and relative proportions of the three building block units, one skilled in the art can obtain an invention bis (α-amino acid)-containing PEA polymer that is both biodegradable and biocompatible and which possesses a wide range of thermo-mechanical properties.

In certain embodiments, a bioactive agent can be covalently bound to the biodegradable polymers via a wide variety of suitable functional groups. For example, when the biodegradable polymer is a polyester, the carboxylic group chain end can be used to react with a complimentary moiety on the bioactive agent, such as hydroxy, amino, thio, and the like. A wide variety of suitable reagents and reaction conditions are disclosed, e.g., in March's Advanced Organic Chemistry, Reactions, Mechanisms, and Structure, Fifth Edition, (2001); and Comprehensive Organic Transformations, Second Edition, Larock (1999).

In other embodiments, a bioactive agent can be dispersed into the polymer by “loading” onto the polymer without formation of a chemical bond or the bioactive agent can be linked to any free functional group in the polymers, such as an amine, hydroxyl (alcohol), or thiol, and the like, to form a direct linkage. Such a linkage can be formed from suitably ftmctionalized starting materials using synthetic procedures that are known in the art.

For example, a polymer of the present invention can be linked to the bioactive agent via a carboxyl group (e.g., COOH) of the polymer. Specifically, a compound of structures (I and II) can react with an amino functional group of a bioactive agent or a hydroxyl functional group of a bioactive agent to provide a biodegradable, biocompatible polymer having the bioactive agent attached via an amide linkage or ester linkage, respectively. In another embodiment, the carboxyl group of the polymer can be transformed into an acyl halide, acyl anhydride/“mixed” anhydride, or active ester.

Alternatively, the bioactive agent may be attached to the polymer via a linker. Indeed, to improve surface hydrophobicity of the biodegradable polymer, to improve accessibility of the biodegradable polymer towards enzyme activation, and to improve the release profile of the biodegradable polymer, a linker may be utilized to indirectly attach the bioactive agent to the biodegradable polymer. In certain embodiments, the linker compounds include poly(ethylene glycol) having a molecular weight (Mw) of about 44 to about 10,000, preferably 44 to 2000; amino acids, such as serine; polypeptides with repeat units from 1 to 100; and any other suitable low molecular weight polymers. The linker typically separates the bioactive agent from the polymer by about 5 angstroms up to about 200 angstroms.

In still further embodiments, the linker is a divalent radical of formula W-A-Q, wherein A is (C₁-C₂₄) alkyl, (C₂-C₂₄) alkenyl, (C₂-C₂₄) alkynyl, (C₂-C₂₀) alkyloxy, (C₃-C₈) cycloalkyl, or (C₆-C₁₀) aryl, and W and Q are each independently —N(R)C(═O)—, —C(═O)N(R)—, —OC(═O)—, —C(═O)O, —O—, —S—, —S(O), —S(O)₂—, —S—S—, —N(R)—, —C(═O)—, wherein each R is independently H or (C₁-C₆) alkyl.

As used herein, the term “alkyl”, as applied to the linkers described herein, refers to a straight or branched chain hydrocarbon group including methyl, ethyl, n-propyl, isopropyl, n-butyl, isobutyl, tert-butyl, n-hexyl, and the like.

As used herein, “alkenyl”, as applied to the linkers described herein, refers to straight or branched chain hydrocarbon groups having one or more carbon-carbon double bonds.

As used herein, “alkynyl”, as applied to the linkers described herein, refers to straight or branched chain hydrocarbon groups having at least one carbon-carbon triple bond.

As used herein, “aryl”, as applied to the linkers described herein, refers to aromatic groups having in the range of 6 up to 14 carbon atoms.

In certain embodiments, the linker may be a polypeptide having from about 2 up to about 25 amino acids. Suitable peptides contemplated for use include poly-L-lysine, poly-L-glutamic acid, poly-L-aspartic acid, poly-L-histidine, poly-L-ornithine, poly-L-threonine, poly-L-tyrosine, poly-L-leucine, poly-L-lysine-L-phenylalanine, poly-L-arginine, poly-L-lysine-L-tyrosine, and the like.

The linker can be attached first to the polymer or to the bioactive agent. During synthesis of polymers having bioactive agents indirectly attached via a linker, the linker can be either in unprotected form or protected from, using a variety of protecting groups well known to those skilled in the art.

In the case of a protected linker, the unprotected end of the linker can first be attached to the polymer or the bioactive agent. The protecting group can then be de-protected using Pd/H₂ hydrogenolysis for saturated polymers, mild acid or base hydrolysis for unsaturated polymers, or any other common de-protection method that is known in the art. The de-protected linker can then be attached to the bioactive agent. An example using poly(ethylene glycol) as the linker is shown in Scheme 1. 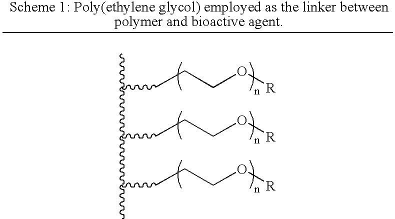
wherein [symbol] represents the polymer; R can be a bioactive agent; and n can range from 1 to 200; preferable from 1 to 50.

The following illustrates synthesis of a polymer composition according to the invention (wherein the bioactive agent is an aminoxyl). A polyester can be reacted with an amino substituted aminoxyl (N-oxide) radical bearing group, e.g., 4-amino-2,2,6,6-tetramethylpiperidine-1-oxy, in the presence of N,N′-carbonyldiimidazole or suitable carbodiimide to replace the hydroxyl moiety in the carboxyl group at the chain end of the polyester with an amino substituted aminoxyl (N-oxide) radical bearing group, so that the amino moiety covalently bonds to the carbon of the carbonyl residue of the carboxyl group to form an amide bond. The N,N′-carbonyldiimidazole or suitable carbodiimide converts the hydroxyl moiety in the carboxyl group at the chain end of the polyester into an intermediate activated moiety which will react with the aminoxyl, e.g., 4-amino-2,2,6,6-tetramethylpiperidine-1-oxy. The aminoxyl reactant is typically used in a mole ratio of reactant to polyester ranging from 1:1 to 100:1. The mole ratio of N,N′-carbonyldiimidazole to aminoxyl is preferably about 1:1.

A typical reaction is as follows. A polyester is dissolved in a reaction solvent and reaction is readily carried out at the temperature utilized for the dissolving. The reaction solvent may be any in which the polyester will dissolve. When the polyester is a polyglycolic acid or a poly(glycolide-L-lactide) (having a monomer mole ratio of glycolic acid to L-lactic acid greater than 50:50), highly refined (99.9+% pure) dimethyl sulfoxide at 115° C. to 130° C. or hexafluoroisopropanol at room temperature suitably dissolves the polyester. When the polyester is a poly-L-lactic acid, a poly-DL-lactic acid or a poly(glycolide-L-lactide) (having a monomer mole ratio of glycolic acid to L-lactic acid 50:50 or less than 50:50), tetrahydrofuran, methylene chloride and chloroform at room temperature to 50° C. suitably dissolve the polyester.

The reaction is typically carried out to substantial completion in 30 minutes to 5 hours. When a polyglycolic acid or a poly(glycolide-L-lactide) from a glycol-rich monomer mixture constitutes the polyester, 2 to 3 hours of reaction time is preferred. When a poly-L-lactic acid is the polyester, the reaction is readily carried out to substantial completion at room temperature for one hour. The reaction is preferably carried out under an inert atmosphere with dry nitrogen purging so as to drive the reaction towards completion.

The product may be precipitated from the reaction mixture by adding cold non-solvent for the product. For example, aminoxyl-containing polyglycolic acid and aminoxyl-containing poly(glycolide-L-lactide) formed from glycolic acid-rich monomer mixture are readily precipitated from hot dimethylsulfoxide by adding cold methanol or cold acetone/methanol mixture and then recovered, e.g., by filtering. When the product is not readily precipitated by adding cold non-solvent for the product, the product and solvent may be separated by using vacuum techniques. For example, aminoxyl-containing poly-L-lactic acid is advantageously separated from solvent in this way. The recovered product is readily further purified by washing away water and by-products (e.g. urea) with a solvent which does not dissolve the product, e.g., methanol in the case of the modified polyglycolic acid, polylactic acid and poly(glycolide-L-lactide) products herein. Residual solvent from such washing may be removed using vacuum drying.

While the optional bioactive agent(s) can be dispersed within the polymer matrix without chemical linkage to the polymer carrier, it is also contemplated that one or more bioactive agents or covering molecules can be covalently bound to the biodegradable polymers via a wide variety of suitable functional groups. For example, a free carboxyl group can be used to react with a complimentary moiety on a bioactive agent or covering molecule, such as a hydroxy, amino, or thio group, and the like. A wide variety of suitable reagents and reaction conditions are disclosed, e.g., in March 's Advanced Organic Chemistry, Reactions, Mechanisms, and Structure, Fifth Edition, (2001); and Comprehensive Organic Transformations, Second Edition, Larock (1999).

In other embodiments, one or more bioactive agent can be linked to any of the polymers of structures (I and II) through an amide, ester, ether, amino, ketone, thioether, sulfinyl, sulfonyl, or disulfide linkage. Such a linkage can be formed from suitably functionalized starting materials using synthetic procedures that are known in the art.

For example, in one embodiment a polymer can be linked to a bioactive agent or adjuvant via a free carboxyl group (e.g., COOH) of the polymer. Specifically, a compound of structures (I) and (II) can react with an amino functional group or a hydroxyl functional group of a bioactive agent to provide a biodegradable polymer having the bioactive agent attached via an amide linkage or ester linkage, respectively. In another embodiment, the carboxyl group of the polymer can be benzylated or transformed into an acyl halide, acyl anhydride/“mixed” anhydride; or active ester. In other embodiments, the free —NH₂ ends of the polymer molecule can be acylated to assure that the bioactive agent will attach only via a carboxyl group of the polymer and not to the free ends of the polymer.

The invention aromatic di-acid-containing PEA polymer compositions can be formulated into particles to provide a variety of properties. The particles can have a variety of sizes and structures suitable to meet differing therapeutic goals and routes of administration using methods described in full in co-pending U.S. application Ser. No. 11/344,689, filed Jan. 31, 2006.

Water soluble covering molecule(s), such as poly(ethylene glycol) (PEG); phosphatidylcholine (PC); glycosaminoglycans including heparin; polysaccharides including chitosan, alginates and polysialic acid; poly(ionizable or polar amino acids) including polyserine, polyglutamic acid, polyaspartic acid, polylysine and polyarginine; as described herein, and targeting molecules, such as antibodies, antigens and ligands, are bioactive agents that can also be conjugated to the polymer on the exterior of particles Qr surgical devices formed from the invention polymer compositions after production to block active sites thereon not occupied by a bioactive agent or to target delivery of the particles to a specific body site as is known in the art. The molecular weights of PEG molecules on a single particle can be substantially any molecular weight in the range from about 200 to about 200,000, so that the molecular weights of the various PEG molecules attached to the particle can be varied.

Alternatively, a bioactive agent or covering molecule can be attached to the polymer via a linker molecule. Indeed, to improve surface hydrophobicity of the biodegradable polymer, to improve accessibility of the biodegradable polymer towards enzyme activation, and to improve the release profile of the bioactive agents from the biodegradable polymer, a linker may be utilized to indirectly attach a bioactive agent to the biodegradable polymer. In certain embodiments, the linker compounds include poly(ethylene glycol) having a molecular weight (Mw) of about 44 to about 10,000, preferably 44 to 2000; amino acids, such as serine; polypeptides with repeat number from 1 to 100; and any other suitable low molecular weight polymers. The linker typically separates the bioactive agent from the polymer by about 5 angstroms up to about 200 angstroms.

In still further embodiments, the linker is a divalent radical of formula W-A-Q, wherein A is (C₁-C₂₄) alkyl, (C₂-C₂₄) alkenyl, (C₂-C₂₄) alkynyl, (C₂-C₂₀) alkyloxy, (C₃-C₈) cycloalkyl, or (C₆-C₁₀) aryl, and W and Q are each independently —N(R)C(═O)—, —C(═O)N(R)—, —OC(═O)—, —C(═O)O, —O—, —S—, —S(O), —S(O)₂—, —S—S—, —N(R)—, —C(═O)—, wherein each R is independently H or (C₁-C₆) alkyl.

As used to describe the above linkers, the term “alkyl” refers to a straight or branched chain hydrocarbon group including methyl, ethyl, n-propyl, isopropyl, n-butyl, isobutyl, tert-butyl, n-hexyl, and the like.

As used to describe the above linkers, “alkenyl” refers to straight or branched chain hydrocarbyl groups having one or more carbon-carbon double bonds.

As used to describe the above linkers, “alkynyl” refers to straight or branched chain hydrocarbyl groups having at least one carbon-carbon triple bond.

As used to describe the above linkers, “aryl” refers to aromatic groups having in the range of 6 up to 14 carbon atoms.

In certain embodiments, the linker may be a polypeptide having from about 2 up to about 25 amino acids. Suitable peptides contemplated for use include poly-L-glycine, poly-L-lysine, poly-L-glutamic acid, poly-L-aspartic acid, poly-L-histidine, poly-L-omithine, poly-L-serine, poly-L-threonine, poly-L-tyrosine, poly-L-leucine, poly-L-lysine-L-phenylalanine, poly-L-arginine, poly-L-lysine-L-tyrosine, and the like.

In one embodiment, a bioactive agent can covalently crosslink the polymer, i.e. the bioactive agent is bound to more than one polymer molecule, to form an intermolecular bridge. This covalent crosslinking can be done with or without a linker containing a bioactive agent.

A bioactive agent molecule can also be incorporated into an intramolecular bridge by covalent attachment between two sites on the same polymer molecule.

A linear polymer polypeptide conjugate is made by protecting the potential nucleophiles on the polypeptide backbone and leaving only one reactive group to be bound to the polymer or polymer linker construct. Deprotection is performed according to methods well known in the art for deprotection of peptides (Boc and Fmoc chemistry for example).

In one embodiment of the present invention, a bioactive agent is a polypeptide presented as a retro-inverso or partial retro-inverso peptide.

In other embodiments, a bioactive agent may be mixed with a photocrosslinkable version of the polymer in a matrix, and, after crosslinking, the material is dispersed (ground) to form particles having an average diameter in the range from about 0.1 to about 10 μm.

Polymer—Bioactive Agent Linkage

In one embodiment, the polymers used to make the invention PEA polymer compositions as described herein have one or more bioactive agent directly linked to the polymer. The residues of the polymer can be linked to the residues of the one or more bioactive agents. For example, one residue of the polymer can be directly linked to one residue of a bioactive agent. The polymer and the bioactive agent can each have one open valence. Alternatively, more than one bioactive agent, multiple bioactive agents, or a mixture of bioactive agents having different therapeutic or palliative activity can be directly linked to the polymer. However, since the residue of each bioactive agent can be linked to a corresponding residue of the polymer, the number of residues of the one or more bioactive agents can correspond to the number of open valences on the residue of the polymer.

As used herein, a “residue of a polymer” refers to a radical of a polymer having one or more open valences. Any synthetically feasible atom, atoms, or functional group of the polymer (e.g., on the polymer backbone or pendant group) is substantially retained when the radical is attached to a residue of a bioactive agent. Additionally, any synthetically feasible functional group (e.g., carboxyl) can be created on the polymer (e.g., on the polymer backbone as a pendant group or as chain termini) to provide the open valence, provided bioactivity of the backbone bioactive agent is substantially retained when the radical is attached to a residue of a bioactive agent. Based on the linkage that is desired, those skilled in the art can select suitably functionalized starting materials that can be used to derivatize the PEA polymers used in the present invention using procedures that are known in the art.

As used herein, a “residue of a compound of structural formula (*)” refers to a radical of a compound of polymer formulas (I and III) as described herein having one or more open valences. Any synthetically feasible atom, atoms, or functional group of the compound (e.g., on the polymer backbone or pendant group) can be removed to provide the open valence, provided bioactivity of the backbone bioactive agent is substantially retained when the radical is attached. Additionally, any synthetically feasible functional group (e.g., carboxyl) can be created on the compound of formulas (I and III) (e.g., on the polymer backbone or pendant group) to provide the open valence, provided bioactivity of the backbone bioactive agent is substantially retained when the radical is attached to a residue of a bioactive agent. Based on the linkage that is desired, those skilled in the art can select suitably functionalized starting materials that can be used to derivatize the compound of formulas (I and III) using procedures that are known in the art.

For example, the residue of a bioactive agent can be linked to the residue of a compound of structural formulas (I and III) through an amide (e.g., —N(R)C(═O)— or C(═O)N(R)—), ester (e.g., —OC(═O)— or —C(═O)O—, ether (e.g., —O—), amino (e.g., —N(R)—), ketone (e.g., —C(═O)—), thioether (e.g., —S—), sulfinyl (e.g., —S(O)—), sulfonyl (e.g., —S(O)₂—), disulfide (e.g., —S—S—), or a direct (e.g., C—C bond) linkage, wherein each R is independently H or (C₁-C₆) alkyl. Such a linkage can be formed from suitably functionalized starting materials using synthetic procedures that are known in the art. Based on the linkage that is desired, those skilled in the art can select suitably functional starting material to derivatize any residue of a compound of structural formulas (I and III) and thereby conjugate a given residue of a bioactive agent using procedures that are known in the art. The residue of the optional bioactive agent can be linked to any synthetically feasible position on the residue of a compound of structural formulas (I and III). Additionally, the invention also provides compounds having more than one residue of a bioactive agent directly linked to a compound of structural formulas (I and III).

The number of bioactive agents that can be linked to the polymer molecule can typically depend upon the molecular weight of the polymer. For example, for a compound of structural formula (I), wherein n is about 5 to about 150, preferably about 2 to about 70, bioactive agent molecules (i.e., residues thereof) can be directly linked to the polymer (i.e., residue thereof) by reacting the bioactive agent with terminal groups of the polymer. On the other hand, for a compound of structural formula (III) up to an additional 150 bioactive agents can be linked to the polymer by reacting the bioactive agent with the pendant group on the adirectional amino acid-containing unit, for example wherein R²═H in an L-lysine-containing unit. In unsaturated polymers, additional bioactive agents can also be reacted with double (or triple) bonds in the polymer.

The invention polymer composition, either in the form of particles or surgical devices, or not, can be covalently attached directly to the bioactive agent, rather than being dispersed or “loaded” into the polymer without chemical attachment, using any of several methods well known in the art and as described hereinbelow. The amount of bioactive agent is generally approximately 0.1% to about 60% (w/w) bioactive agent to polymer composition, more preferably about 1% to about 25% (w/w) bioactive agent, and even more preferably about 2% to about 20% (w/w) bioactive agent. The percentage of bioactive agent will depend on the desired dose and the condition being treated, as discussed in more detail below.

In addition to serving as a stand-alone delivery system for bioactive agents when directly administered in vivo in the form of implantable particles, the invention PEA polymer compositions can be used in the fabrication of various types of surgical devices. In this embodiment, the invention polymer composition used in fabrication of the surgical device is effective for controlled delivery to surrounding tissue of any bioactive agents dispersed in the polymer in the invention polymer composition, for example, covalently attached to the surface thereof.

In one embodiment, the invention aromatic di-acid-containing PEA polymer composition has sufficient stiffness to be fabricated in the form of a biodegradable, biocompatible surgical device, including but not limited to internal fixation devices, such as surgical suture, surgical screws, implantable plates, and implantable rods, or as a vascular stent or dialysis shunt. Any method known in the art for fabrication of biodegradable polymer surgical devices, such as extrusion, injection molding, casting, or solution processing (dry and wet spinning), and the like, can be used for this purpose. Such biodegradable, biocompatible surgical devices slowly biodegrade, for example over a period of from about 14 days to few years, for example one year, three years or six years, depending on device thickness and combination of building blocks in the PEA polymer to create substantially biocompatible breakdown products.

Accordingly, in another embodiment the invention provides methods for treating a subject in need thereof comprising implanting an invention surgical device at an interior body site so that the device slowly biodegrades, for example completely. Any dispersed bioactive agent, as described herein, dispersed in the polymer from which the device is fabricated will be slowly released to tissue surrounding a site of implantation during biodegradation of the device, for example to promote healing or alleviate pain therein. For example, the bioactive agent released from the surgical device, for example when fabricated as a vascular stent, promotes endogenous healing processes at the wound site by contact with the surroundings into which the surgical device is implanted. In embodiments wherein the device is fabricated of a polymer designed to be completely biodegradable, no additional surgery is required to remove the implanted surgical device due to its biodegradation properties.

In another embodiment, the invention aromatic di-acid-containing PEA polymer composition can be fabricated in the form of a biodegradable, biocompatible pad, sheet or wrap of any desired surface area. For example, the polymer can be woven or formed as a thin sheet of randomly oriented fibers by electrospinning to produce nanofibers of the polymer. Such pads, sheets and wraps can be used in a number of types of wound dressings for treatment of a variety of conditions, for example by promoting endogenous healing processes at a wound site. Such wound dressings can be implanted at an interior body site or applied to a body surface, depending upon the needs of the subject. For example, such a wound dressing can be applied to the surface of burned or injured skin. The invention PEA polymer in such a wound dressing biodegrades over time, releasing a bioactive agent dispersed therein to be absorbed into a wound site where it acts intracellularly, either within the cytosol, the nucleus, or both, of a target cell. Alternatively, the bioactive agent can bind to a cell surface receptor molecule to elicit a cellular response without entering the cell. A detailed description of wound dressings, wound healing implants and surgical device coatings made using related PEA polymers is found in co-pending U.S. patent application Ser. No. 11/128,903, filed May 12, 2005.

Bioactive agents contemplated for dispersion within the polymers used in the invention aromatic di-acid-containing PEA polymer compositions include anti-proliferants, rapamycin and any of its analogs or derivatives, paclitaxel or any of its taxene analogs or derivatives, everolimus, sirolimus, tacrolimus, or any of its -limus named family of drugs, and statins such as simvastatin, atorvastatin, fluvastatin, pravastatin, lovastatin, rosuvastatin, geldanamycins, such as 17AAG (17-allylamino-17-demethoxygeldanamycin); Epothilone D and other epothilones, 17-dimethylaminoethylamino-17-demethoxy-geldanamycin and other polyketide inhibitors of heat shock protein 90 (Hsp90), cilostazol, and the like.

Suitable bioactive agents for dispersion in the invention aromatic di-acid-containing PEA polymer compositions and particles made therefrom also can be selected from those that promote endogenous production of a therapeutic natural wound healing agent, such as nitric oxide, which is endogenously produced by endothelial cells. Alternatively the bioactive agents released from the polymers during degradation may be directly active in promoting natural wound healing processes by endothelial cells. These bioactive agents can be any agent that donates, transfers, or releases nitric oxide, elevates endogenous levels of nitric oxide, stimulates endogenous synthesis of nitric oxide, or serves as a substrate for nitric oxide synthase or that inhibits proliferation of smooth muscle cells. Such agents include, for example, aminoxyls, furoxans, nitrosothiols, nitrates and anthocyanins; nucleosides such as adenosine and nucleotides such as adenosine diphosphate (ADP) and adenosine triphosphate (ATP); neurotransmitter/neuromodulators such as acetylcholine and 5-hydroxytryptamine (serotonin/5-HT); histamine and catecholamines such as adrenalin and noradrenalin; lipid molecules such as sphingosine-1-phosphate and lysophosphatidic acid; amino acids such as arginine and lysine; peptides such as the bradykinins, substance P and calcium gene-related peptide (CGRP), and proteins such as insulin, vascular endothelial growth factor (VEGF), and thrombin.

A variety of bioactive agents, coating molecules and ligands for bioactive agents can be attached, for example covalently, to the surface of the polymer particles. Bioactive agents, such as targeting antibodies, polypeptides (e.g., antigens) and drugs can be covalently conjugated to the surface of the polymer particles. In addition, coating molecules, such as polyethylene glycol (PEG) as a ligand for attachment of antibodies or polypeptides or phosphatidylcholine (PC) as a means of blocking attachment sites on the surface of the particles, can be surface-conjugated to the particles to prevent the particles from sticking to non-target biological molecules and surfaces in a subject to which the particles are administered.

For example, small proteinaceous motifs, such as the B domain of bacterial Protein A and the functionally equivalent region of Protein G are known to bind to, and thereby capture, antibody molecules by the Fc region. Such proteinaceous motifs can be attached as bioactive agents to the invention polymers and compositions, especially to the surface of the polymer particles described herein. Such molecules will act, for example, as ligands to attach antibodies for use as targeting ligands or to capture antibodies to hold precursor cells or capture cells out of the blood stream. Therefore, the antibody types that can be attached to polymer coatings using a Protein A or Protein G functional region are those that contain an Fc region. The capture antibodies will in turn bind to and hold precursor cells, such as progenitor cells, near the polymer surface while the precursor cells, which are preferably bathed in a growth medium within the polymer, secrete various factors and interact with other cells of the subject. In addition, one or more bioactive agents dispersed in the polymer particles, such as the bradykinins, may activate the precursor cells.

In addition, bioactive agents for attaching precursor cells or for capturing progenitor endothelial cells (PECs) from a blood stream in a subject to which the polymer compositions are administered are monoclonal antibodies directed against a known precursor cell surface marker. For example, complementary determinants (CDs) that have been reported to decorate the surface of endothelial cells include CD31, CD34, CD102, CD105, CD106, CD109, CDw130, CD141, CD142, CD143, CD144, CDw145, CD146, CD147, and CD166. These cell surface markers can be of varying specificity and the degree of specificity for a particular cell/developmental type/stage is in many cases not fully characterized. In addition, these cell marker molecules against which antibodies have been raised will overlap (in terms of antibody recognition) especially with CDs on cells of the same lineage: monocytes in the case of endothelial cells. Circulating endothelial progenitor cells are some way along the developmental pathway from (bone marrow) monocytes to mature endothelial cells. CDs 106, 142 and 144 have been reported to mark mature endothelial cells with some specificity. CD34 is presently known to be specific for progenitor endothelial cells and therefore is currently preferred for capturing progenitor endothelial cells out of blood in the site into which the polymer particles are implanted for local delivery of the active agents. Examples of such antibodies include single-chain antibodies, chimeric antibodies, monoclonal antibodies, polyclonal antibodies, antibody fragments, Fab fragments, IgA, IgG, IgM, IgD, IgE and humanized antibodies, and active fragments thereof.

The following bioactive agents and small molecule drugs will be particularly effective for dispersion within the invention aromatic di-acid-containing PEA polymer compositions when selected for their suitable therapeutic or palliative effect in treatment of a wound or interior body condition of interest.

In one embodiment, the suitable bioactive agents are not limited to, but include, various classes of compounds that facilitate or contribute to wound healing when presented in a time-release fashion. Such bioactive agents include wound-healing cells, including certain precursor cells, which can be protected and delivered by the biodegradable polymer in the invention compositions. Such wound healing cells include, for example, pericytes and endothelial cells, as well as inflammatory healing cells. To recruit such cells to the site of an implanted device comprising an invention PEA polymer in vivo, the invention aromatic di-acid-containing PEA polymer compositions, such as implantable surgical devices or particles thereof used in the invention methods of use can include ligands for such cells, such as antibodies and smaller molecule ligands, that specifically bind to “cellular adhesion molecules” (CAMs). Exemplary ligands for wound healing cells include those that specifically bind to Intercellular adhesion molecules (ICAMs), such as ICAM-1 (CD54 antigen); ICAM-2 (CD102 antigen); ICAM-3 (CD50 antigen); ICAM-4 (CD242 antigen); and ICAM-5; Vascular cell adhesion molecules (VCAMs), such as VCAM-1 (CD106 antigen); Neural cell adhesion molecules (NCAMs), such as NCAM-1 (CD56 antigen); or NCAM-2; Platelet endothelial cell adhesion molecules PECAMs, such as PECAM-1 (CD31 antigen); Leukocyte-endothelial cell adhesion molecules (ELAMs), such as LECAM-1; or LECAM-2 (CD62E antigen), and the like.

In another aspect, the suitable bioactive agents include extra cellular matrix proteins, macromolecules that can be dispersed into the polymer particles used in the invention aromatic di-acid-containing PEA polymer compositions, e.g., attached either covalently or non-covalently. Examples of useful extra-cellular matrix proteins include, for example, glycosaminoglycans, usually linked to proteins (proteoglycans), and fibrous proteins (e.g., collagen; elastin; fibronectins and laminin). Bio-mimics of extra-cellular proteins can also be used. These are usually non-human, but biocompatible, glycoproteins, such as alginates and chitin derivatives. Wound healing peptides that are specific fragments of such extra-cellular matrix proteins and/or their bio-mimics can also be used.

Proteinaceous growth factors are another category of bioactive agents suitable for dispersion in the invention aromatic di-acid-containing PEA polymer compositions and methods of use described herein. Such bioactive agents are effective in promoting wound healing and other disease states as is known in the art, for example, Platelet Derived Growth Factor-BB (PDGF-BB), Tumor Necrosis Factor-alpha (TNF-alpha), Epidermal Growth Factor (EGF), Keratinocyte Growth Factor (KGF), Thymosin B4; and, various angiogenic factors such as vascular Endothelial Growth Factors (VEGFs), Fibroblast Growth Factors (FGFs), Tumor Necrosis Factor-beta (TNF-beta), and Insulin-like Growth Factor-1 (IGF-1). Many of these proteinaceous growth factors are available commercially or can be produced recombinantly using techniques well known in the art.

Alternatively, expression systems comprising vectors, particularly adenovirus vectors, incorporating genes encoding a variety of biomolecules can be dispersed in the invention aromatic di-acid-containing polymer compositions and particles thereof for timed release delivery. Methods of preparing such expression systems and vectors are well known in the art. For example, proteinaceous growth factors can be dispersed into the invention bioactive compositions for administration of the growth factors either to a desired body site for local. delivery, by selection of particles sized to form a polymer depot, or systemically, by selection of particles of a size that will enter the circulation. Growth factors, such as VEGFs, PDGFs, FGF, NGF, and evolutionary and functionally related biologics, and angiogenic enzymes, such as thrombin, may also be used as bioactive agents in the invention.

Small molecule drugs are yet another category of bioactive agents suitable for dispersion in the invention aromatic di-acid-containing PEA polymer compositions and methods of use described herein. Such drugs include, for example, antimicrobials and anti-inflammatory agents as well as certain healing promoters, such as, for example, vitamin A and synthetic inhibitors of lipid peroxidation.

A variety of antibiotics can be dispersed as bioactive agents in the invention aromatic di-acid-containing PEA polymer compositions to indirectly promote natural healing processes by preventing or controlling infection. Suitable antibiotics include many classes, such as aminoglycoside antibiotics or quinolones or beta-lactams, such as cefalosporins, e.g., ciprofloxacin, gentamycin, tobramycin, erythromycin, vancomycin, oxacillin, cloxacillin, methicillin, lincomycin, ampicillin, and colistin. Suitable antibiotics have been described in the literature.

Suitable antimicrobials include, for example, Adriamycin PFS/RDF® (Pharmacia and Upjohn), Blenoxane® (Bristol-Myers Squibb Oncology/Immunology), Cerubidine® (Bedford), Cosmegen® (Merck), DaunoXom® (NeXstar), Doxil® (Sequus), Doxorubicin Hydrochlorides (Astra), Idamycin® PFS (Pharmacia and Upjohn), Mithracin® (Bayer), Mitamycin® (Bristol-Myers Squibb Oncology/Immunology), Nipen® (SuperGen), Novantrone® (Immunex) and Rubex® (Bristol-Myers Squibb Oncology/Immunology). In one embodiment, the peptide can be a glycopeptide. “Glycopeptide” refers to oligopeptide (e.g. heptapeptide) antibiotics, characterized by a multi-ring peptide core optionally substituted with saccharide groups, such as vancomycin.

Examples of glycopeptides included in this category of antimicrobials may be found in “Glycopeptides Classification, Occurrence, and Discovery,” by Raymond C. Rao and Louise W. Crandall, (“Bioactive agents and the Pharmaceutical Sciences” Volume 63, edited by Ramakrishnan Nagarajan, published by Marcal Dekker, Inc.). Additional examples of glycopeptides are disclosed in U.S. Pat. Nos. 4,639,433; 4,643,987; 4,497,802; 4,698,327, 5,591,714; 5,840,684; and 5,843,889; in-EP 0 802 199; EP 0 801 075; EP 0 667 353; WO 97/28812; WO 97/38702; WO 98/52589; WO 98/52592; and in J. Amer. Chem. Soc. (1996) 118: 13107-13108; J. Amer. Chem. Soc. (1997) 119:12041-12047; and J. Amer. Chem. Soc. (1994) 116:4573-4590. Representative glycopeptides include those identified as A477, A35512, A40926, A41030, A42867, A47934, A80407, A82846, A83850, A84575, AB-65, Actaplanin, Actinoidin, Ardacin, Avoparcin, Azureomycin, Balhimyein, Chloroorientiein, Chloropolysporin, Decaplanin, -demethylvancomycin, Eremomycin, Galacardin, Helvecardin, Izupeptin, Kibdelin, LL-AM374, Mannopeptin, MM45289, MM47756, MM47761, MM49721, MM47766, MM55260, MM55266, MM55270, MM56597, MM56598, OA-7653, Orenticin, Parvodicin, Ristocetin, Ristomycin, Symnonicin, Teicoplanin, UK-68597, UD-69542, UK-7205 1, Vancomycin, and the like. The term “glycopeptide” or “glycopeptide antibiotic” as used herein is also intended to include the general class of glycopeptides disclosed above on which the sugar moiety is absent, i.e. the aglycone series of glycopeptides. For example, removal of the disaccharide moiety appended to the phenol on vancomycin by mild hydrolysis gives vancomycin aglycone. Also included within the scope of the term “glycopeptide antibiotics” are synthetic derivatives of the general class of glycopeptides disclosed above, including alkylated and acylated derivatives. Additionally, within the scope of this term are glycopeptides that have been further appended with additional saccharide residues, especially aminoglycosides, in a manner similar to vancosamine.

The term “lipidated glycopeptide” refers specifically to those glycopeptide antibiotics that have been synthetically modified to contain a lipid substituent. As used herein, the term .“lipid substituent” refers to any substituent contains 5 or more carbon atoms, preferably, 10 to 40 carbon atoms. The lipid substituent may optionally contain from 1 to 6 heteroatoms selected from halo, oxygen, nitrogen, sulfur, and phosphorous. Lipidated glycopeptide antibiotics are well known in the art. See, for example, in U.S. Pat. Nos. 5,840,684, 5,843,889, 5,916,873, 5,919,756, 5,952,310, 5,977,062, 5,977,063, EP 667, 353, WO 98/52589, WO 99/56760, WO 00/04044, WO 00/39156, the disclosures of which are incorporated herein by reference in their entirety.

Anti-inflammatory bioactive agents are also useful for dispersion in used in invention aromatic di-acid-containing PEA polymer compositions and methods. Depending on the body site and disease to be treated, such anti-inflammatory bioactive agents include, e.g. analgesics (e.g., NSAIDS and salicyclates), steroids, antirheumatic agents, gastrointestinal agents, gout preparations, hormones (glucocorticoids), nasal preparations, ophthalmic preparations, otic preparations (e.g., antibiotic and steroid combinations), respiratory agents, and skin & mucous membrane agents. See, Physician's Desk Reference, 2005 Edition. Specifically, the anti-inflammatory agent can include dexamethasone, which is chemically designated as (119, 16I)-9-fluro-11,17,21-trihydroxy-16-methylpregna-1,4-diene-3,20-dione. Alternatively, the anti-inflammatory bioactive agent can be or include sirolimus (rapamycin), which is a triene macrolide antibiotic isolated from Streptomyces hygroscopicus.

The polypeptide bioactive agents included in the invention compositions and methods can also include “peptide mimetics.” Such peptide analogs, referred to herein as “peptide mimetics” or “peptidomimetics,” are commonly used in the pharmaceutical industry with properties analogous to those of the template peptide (Fauchere, J. (1986) Adv. Bioactive agent Res., 15:29; Veber and Freidinger (1985) TINS, p. 392; and Evans et al. (1987) J. Med. Chem., 30:1229) and are usually developed with the aid of computerized molecular modeling. Generally, peptidomimetics are structurally similar to a paradigm polypeptide (i.e., a polypeptide that has a biochemical property or pharmacological activity), but have one or more peptide linkages optionally replaced by a linkage selected from the group consisting of: —CH₂NH—, —CH₂S—, CH₂—H₂—, —CH═CH— (cis and trans), —COCH₂—, —CH(OH)CH₂—, and —CH₂SO—, by methods known in the art and further described in the following references: Spatola, A. F. in Chemistry and Biochemistry of Amino Acids, Peptides, and Proteins, B. Weinstein, eds., Marcel Dekker, New York, p. 267 (1983); Spatola, A. F., Vega Data (March 1983), Vol. 1, Issue 3, “Peptide Backbone Modifications” (general review); Morley, J. S., Trends. Pharm. Sci., (1980) pp. 463-468 (general review); Hudson, D. et al., Int. J. Pept. Prot. Res., (1979) 14:177-185 (—CH₂NH—, CH₂CH₂—); Spatola, A. F. et al., Life Sci., (1986) 38:1243-1249 (—CH₂—S—); Harm, M. M., J. Chem. Soc. Perkin Trans I(1982) 307-314 (—CH═CH—, cis and trans); Almquist, R. G. et al., J. Med. Chem., (1980) 23:2533 (—COCH₂—); Jennings-Whie, C. et al., Tetrahedron Lett., (1982) 23:2533 (—COCH₂—); Szelke, M. et al., European Appln., EP 45665 (1982) CA: 97:39405 (1982) (—CH(OH)CH₂—); Holladay, M. W. et al., Tetrahedron Lett., (1983) 24:4401-4404 (—C(OH)CH₂—); and Hruby, V. J., Life Sci., (1982) 31:189-199 (—CH₂—S—). Such peptide mimetics may have significant advantages over natural polypeptide embodiments, including, for example: more economical production, greater chemical stability, enhanced pharmacological properties (half-life, absorption, potency, efficacy, etc.), altered specificity (e.g., a broad-spectrum of biological activities), reduced antigenicity, and others.

Additionally, substitution of one or more amino acids within a peptide (e.g., with a D-lysine in place of L-lysine) may be used to generate more stable peptides and peptides resistant to endogenous peptidases. Alternatively, the synthetic pblypeptides covalently bound to the biodegradable polymer, can also be prepared from D-amino acids, referred to as inverso peptides. When a peptide is assembled in the opposite direction of the native peptide sequence, it is referred to as a retro peptide. In general, polypeptides prepared from D-amino acids are very stable to enzymatic hydrolysis. Many cases have been reported of preserved biological activities for retro-inverso or partial retro-inverso polypeptides (U.S. Pat. No. 6,261,569 B1 and references therein; B. Fromme et al, Endocrinology (2003)144:3262-3269.

Any suitable and effective amount of the at least one bioactive agent can be released with time from the invention polymer composition, including those in a biodegradable internal fixation device, stent, or dialysis shunt, or in a depot formed from particles thereof introduced in vivo. The suitable and effective amount of the bioactive agent will typically depend, e.g., on the specific aromatic di-acid-containing PEA polymer and type of particle or polymer/bioactive agent linkage, if present. Typically, up to about 100% of the bioactive agent(s) can be released from the invention polymer in vivo. Specifically, up to about 90%, up to 75%, up to 50%, or up to 25% thereof can be released from the polymer. Factors that typically affect the release rate from the polymer are the types of polymer/bioactive agent linkage, and the nature and amount of additional substances present in the formulation.

In addition to humans, the invention aromatic di-acid-containing PEA polymer compositions, as well as particles and surgical devices fabricated therefrom, are also intended for use in veterinary practice, including a variety of mammalian patients, such as pets (for example, cats, dogs, rabbits, and ferrets), farm animals (for example, swine, horses, mules, dairy and meat cattle) and race horses.

In certain embodiments, the bioactive agent(s) used in the invention compositions, devices and methods of administration will comprise an “effective amount” of one or more bioactive agents of interest. That is, an amount of a bioactive agent will be incorporated into the polymer that will produce a sufficient therapeutic or palliative response in order to prevent, reduce or eliminate symptoms. The exact amount necessary will vary, depending on the subject to which the composition is being administered; the age and general condition of the subject; the capacity of the subject's immune system, the degree of therapeutic or palliative response desired; the severity of the condition being treated or investigated; the particular bioactive agent selected and mode of administration of the composition, among other factors. An appropriate effective amount can be readily determined by one of skill in the art. Thus, an “effective amount” will fall in a relatively broad range that can be determined through routine trials. For example, for purposes of the present invention, an effective amount will typically range from about 1 μg to about 100 mg, for example from about 5 jig to about 1 mg, or about 10 μg to about 500 μg of the bioactive agent delivered.

The following examples are meant to illustrate, but not to limit the invention.

### EXAMPLE 1

Materials:

4-hydroxybenzoic acid, 1,3-dibromopropane, p-nitrophenol, thionyl chloride, oxalyl chloride, triethylamine, and anhydrous N,N-dimethylformamide (DMF) were purchased from Aldrich Chemicals (St. Louis, Mo.), and used without further purification. Chloroform and chlorobenzene were dried over 4A molecular sieves. Other solvents and reagents: diethyl ether, ethyl acetate, sodium carbonate, sodium sulfate were purchased from Fisher Chemicals (UK).

Materials Characterization

NMR spectra were recorded by a Bruker AMX-500 spectrometer (Numega R. Labs, San Diego, Calif.) operating at 500 MHz for ¹H NMR spectroscopy. Deuterated solvents CDCl₃ or DMSO-d₆ (Cambridge Isotope Laboratories, Cambridge, Mass.) were used with tetramethylsilane (TMS) as internal standard.

Melting points of monomers were determined on automatic Mettler Toledo FP62 Melting Point Apparatus (Mettler-Toledo International, Inc). Thermal properties of monomers and polymers were characterized on Mettler Toledo DSC 822e differential scanning calorimeter. Samples were placed in aluminum pans. Measurements were carried out at a scanning rate of 10° C./min under nitrogen flow.

The number and weight average molecular weights (Mw and Mn) and molecular weight distribution of synthesized polymers were determined by Model 515 gel permeation chromatography (Waters Associates, Milford, Mass.) equipped with a high pressure liquid chromatographic pump, a Waters 2414 refractory index detector with 0.1% of LiCi solution in DMAc used as eluent (1.0 mL/min). Two Styragel HR 5E DMF type columns (Waters Associates) were connected and calibrated with polystyrene standards.

Tensile strength, % elongation at break, and Young's Modulus were measured on tensile strength machine (Chatillon TCD200) integrated with a PC and Nexygen FM software (Amatek, Largo, Fla.) at a crosshead speed of 100 mm/min. The load capacity was 50 lbs. The film (4×1.6 cm) had a dumbbell shape and thickness of about 0.125 mm.

Monomer Synthesis:

### CPP Synthesis (Compound 1)

Into a round bottom flask equipped with magnetic stirrer and reflux condenser, 30 g (0.2172 mol) of 4-hydroxybenozoyc acid was dissolved in 220 mL of 2M sodium hydroxide solution. Then 11.1 mL (0.1086 mmol) of 1,3-dibromopropane was introduced and the reaction mixture was heated to reflux while being stirred. Heating continued for 16 hours and then the cooled solution was poured into 700 mL of 1M HCl. A white paste formed and was filtered. An off-white solid obtained by filtration was suspended in H₂O/Etanol 1:1 solution, re-filtered and dried in an oven under vacuum. Yield was 21.3 g (62%) white solid collected-with melting point (mp) of 310° C. obtained as described above compared to a literature mp of 310° C. (Aldrich Chemicals). Product was recrystallized from DMF:water, 1:1 w/w.

### Di-p-nitrophenyl ester of CPP (Compound 4)

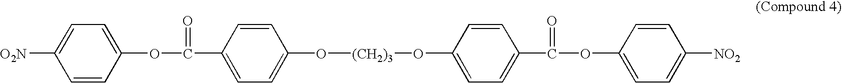

Preparation of this compound has been carried out by two different methods:

Method A: Direct condensation of CPP with p-nitrophenol, using thionyl chloride as condensing reagent.

A three-neck round-bottom flask, equipped with magnetic stirrer, addition funnel, reflux condenser, and nitrogen in- and outlet was charged with 7.9 g. (25 mmol) of CPP (compound 1), 7.3 g (52.5 mmol) of p-nitrophenol, and a few drops of DMF and 100 mL of dry chlorobenzene. To this mixture a solution of 4 ml (54.8 mmol) thionyl chloride in 10 mL of chlorobenzene was added drop-wise at ambient temperature for 20 min. time period. Then the reaction mixture was heated to 79° C. while a slow stream of nitrogen was introduced to evacuate formed gases. After 8 h, the reaction mixture became homogenous. The cooled solution was diluted with 120 mL hexane and left over night at 0° C. Yellow crystals of compound 2 were collected by filtration, washed with hexane and dried in vacuum over night at 45° C. Yield was 10.3g, (74%.). Recrystallization from acetone yielded pale yellow crystals, mp 161.6° C.

¹HNMR, δ (DMSO-d₆, 500 MHz): 8.33 (d, 4H, Ar), 8.10 (d, 4H, Ar), 7.58 (d, 4H, Ar), 7.17 (d, 4H, Ar), 4.29 (t, 4H, —O—CH₂—), 2.27 (m, 2H, —CH₂—CH₂—).

Method B: Because thionyl chloride is a controlled substance no longer readily available, a two step synthesis via acid chloride was developed, illustrated in this example using oxalyl chloride.

First step: synthesis of CPP-dichloride: 9.2g (29.1 mmol) of CPP and a few drops of pyridine were suspended into 120 mL of dry chloroform in 500 mL round-bottom flask. Using an addition funnel, at room temperature, 35 mL of 2 M oxalyl chloride solution (Aldrich) in dichloromethane was added dropwise with stirring. Stirring was continued for 1 h and the solution was heated to reflux for another 6 hours: the white suspension turned into a yellow homogeneous solution. After cooling, a clear reaction solution was filtered through glass frit under inert atmosphere to remove thermo-mechanical impurities and the filtrate was diluted with 500 mL of hexane. Yellow crystals separated from the filtrate after standing over night, being, filtered under argon, placed in round-bottom flask and dried under vacuum at room temp. Crude product with the yield of 9.8 g. (95%) was converted to activated ester, without further recrystallization.

Second step. condensation of CPP-dichloride with p-nitrophenol To the chilled (0° C.) solution of 8 g (57.5 mmol) of p-nitrophenol and 8.1 mL of triethylarnine in 100 mL of dry ethylacetate a solution of 9.8 g (27.8 mmol) CPP-dichloride in 150 mL of ethylacetate was added dropwise over 30 min. Then, the reaction mixture was warmed to room temperature for 8 hours before heating to 45° C. for another 2 hours. Ethylacetate was evaporated and obtained solid product was first washed with acidified water (pH 2-3), then with deionized water and dried. Yield was 9.0 g (92%). Product was recrystallized from acetone.

### Synthesis of di-p-nitrophenyl esters of Sebacic Acid (Compound 5)

Di-p-nitrophenyl ester of sebacic acid was prepared by reacting of sebacoyl chloride with p-nitrophenol as described previously (Katsarava et al. J. Polym. Sci. Part A: Polym. Chem. (1999) 37.391-407):

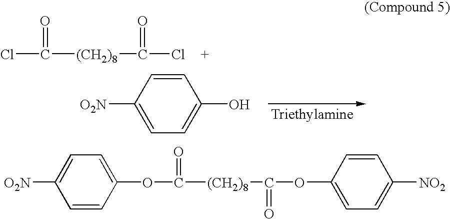

For the polymerization other required monomers were bis-electrophiles based on amino acids and aliphatic diols, both of which were synthesized according to previously published procedures.

### Preparation of di-p-toluenesulfonic acid salt of bis-L-leucine-hexane-1,6-diester (Compound 6)

Synthesis of tosylate salts of diamines as nucleophilic monomers has been described previously in U.S. Pat. No. 6,503,538 B1 and in provisional U.S. application Ser. No. 60/687,570, filed Jun. 3, 2005. Di-p-toluenesulfonic acid salt of bis-L-leucine-hexane-1,6-diester (Compound 6) was prepared by a modification of the previously published method 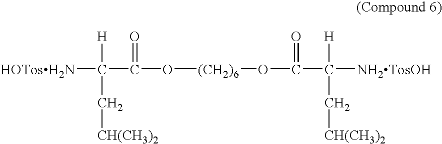
wherein L-leucine (0.132 mol), p-toluenesulfonic acid monohydrate (0.132 mol) and 1,6-hexane diol (0.06 mol) in 250 mL of toluene were placed in a flask equipped with a Dean-Stark apparatus and overhead stirrer. The heterogeneous reaction mixture was heated to reflux for about. 12 h until 4.3 mL (0.24 mol) of water evolved. The reaction mixture was then cooled to room temperature, filtered, washed with acetone, and recrystallized twice from methanol/toluene 2:1 mixture. Yield and mp obtained as described above were identical to published data (R. Katsarava et al. J. Polym. Sci., Part A: Polym. Chem. (1999) 37:391-407).

### Preparation of di-p-Toluenesulfonic Acid Salt of O,O′-bis(L-leucinyl)-l, 4:3,6-dianhydrosorbitol-diester (Compound 7).

Preparation of di-p-Toluenesulfonic acid salt of O,O′-bis(L-leucinyl)-1,4:3,6-dianhydrosorbitol-diester (Compound 6) was carried out analogously to that of Compound 3 by reacting isosorbide with L-leucine in refluxing toluene in the presence of p-toluenesulfonic acid monohydrate with a Dean-Stark equipment as previously described (Z. Gomurashvili, et al. J. Macromol. Sci. Pure Appl. Chem. (2000) A37: 215-227).

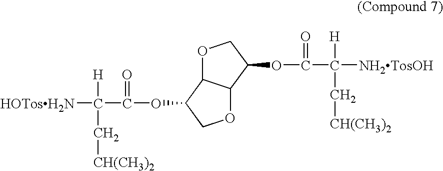

### Preparation of Di-p-toluenesulfonic Acid Salt of L-lysine benzyl ester (Compound 8)

Di-p-toluenesulfonic acid salt of L-lysine benzyl ester (Compound 7) was prepared as described previously in U.S. Pat. Nos. 6,503,538 B1 by refluxing of benzyl alcohol, toluenesulfonic acid monohydrate and L-lysine monohydrochloride in toluene, while applying azeotropic removal of water. 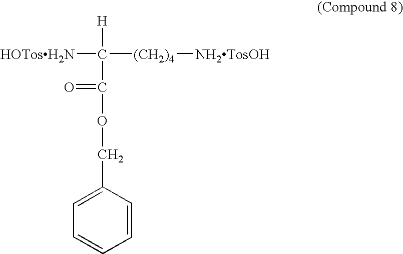
Polymer Synthesis:

Preparation of PEA Polymer # 3, in Table 1. To the stirred mixture of 9 mmol of Compound 6, 3 mmol of Compound 8, 6 mmol of pNP-CPP (Compound 4) and 6 mmol of compound 5 in 8.5 mL of anhydrous N,N-dimethylformamide, 12.3 mmol of triethylamine was added and heated at 65° C. for 24 hours. In all cases the reaction proceeded homogenously. The obtained viscous reaction solution was poured into cold water and precipitated product was filtered off and thoroughly washed with water. Crude polymer was dried, resuspended in 100 mL chloroform, and p-nitrophenyl residue was extracted with water several times. The organic phase was dried over sodium sulfate, filtered, and concentrated by solvent evaporation. Polymer was precipitated in ethylacetate. Yields and polymer properties are as summarized in Table 1 herein.

Polymer Characterization

Four different poly(ester amides) were prepared using the technique illustrated above, but with various proportional combinations (feed ratios) of sebacic acid and CPP. The exemplary aromatic di-acid-containing PEA polymers have properties as summarized in Table I herein and have chemical structures described by the following formula XII: 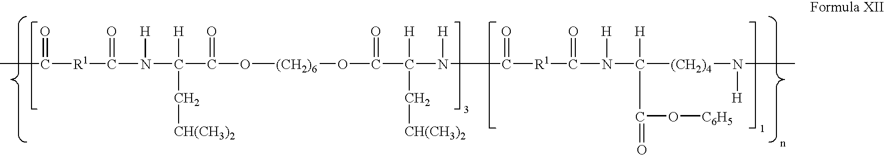
wherein for sebacic acid (R¹═—(CH₂)₈—) and/or for CPP (R¹═—C₆H₄—O—(CH₂)₃—O—C₆H₄—).

In all cases the reaction proceeded homogenously. The polymers displayed an increase of glass transition temperature (Tg) directly proportional to the amount of CPP di-acid residue contained in the polymer (e.g. increase in feed ratio of CPP:aliphatic di-acid(s) used in preparation). In addition Tg of the exemplary invention polymers was above physiological temperature, in the range from 45° C. to 78° C. (Table 1). Tg was also increased by substitution of an aliphatic linear 1,6-hexanediol residue in the place of the residue of a bi-cyclic aliphatic sugar-diol, such as isosorbide (See #4 in Table 1).

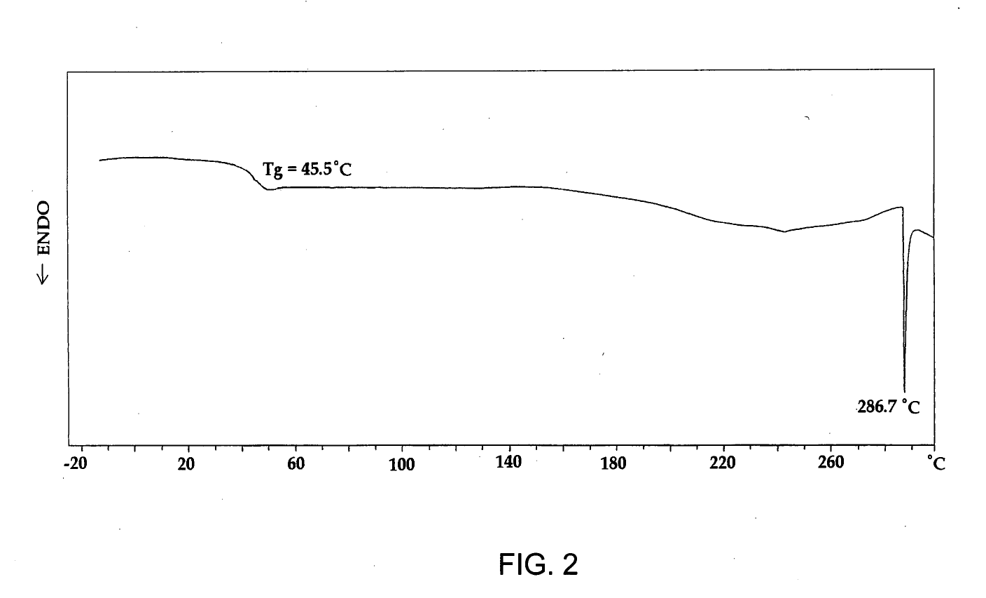

Differential Scanning Calorimetry heating traces of polymers with more than 35% CPP di-acid content show the presence of melting endotherms (FIG. 2), a phenomenon generally characteristic of semi-crystalline materials. Wetting properties (hydrophilicity) as well as capacity for water uptake of the invention PEAs decreases as the content of CPP di-acid residues increases.

By contrast, the elastic properties (% elongation) of the exemplary CCP-containing PEA polymers decreased in proportion to the amount of CCP residues in the polymers, an effect attributed to the rigid phenyl groups in CCP.

In addition, it was discovered that increasing the proportion of CPP in the di-acid feed ratio to greater than 25% in PEA polymers decreases solubility of the polymer in ethanol. However, the PEA polymer is still soluble in chloroform, dichloromethane and aprotic polar solvents like N,N-Dimethylformamide (DMF), N,N-Dimethylacetamide (DMAc), and dimethylsulfoxide (DMSO).

### EXAMPLE 2

Materials

The compounds trans-3-hydroxycinnamic acid, trans-4-hydroxycinnamic acid, adipoyl chloride, sebacoyl chloride, oxalyl chloride (2M in methylene chloride) and pyridine were purchased from Aldich Chemicals (St, Louis, Mo.), and used without further purification. Anhydrous solvents, tetrahydrofurane and N′N-dimethylformamide (DMF, Aldrich) were used as received.

Monomer Synthesis:

### Synthesis of 3,3′-(adipoyldioxy)dicinnamic Acid (Compound 3).

A solution of 3-Hydroxycinnamic acid (8.2 g, 0.05 mol) dissolved in 100 mL of 2N sodium hydroxide solution was vigorously stirred and cooled to about 5° C. At once adipoyl chloride (4.6 g, 0.025 mol) diluted with 25 mL of dry chloroform was added. After 30 min of stirring, whole precipitate was filtered off, washed with water, in 1N HCl, and dried. Product recrystallized from DMSO/ethanol/water (pH 2-3) to yield 6.6 g (56%) of compound 3, m.p. 238-239° C. (decomp.). Elemental Analysis, C₂₄H₂₂O₈: Calculated values: C: 65.75, H: 5.06; Found values: C: 65.27, H: 5.34. Mono-substituted by-product, 3-adipoyldioxydicinnamic acid, (about 37% of the overall product, m.p. 192-194° C.), gained from mother liquor, was presumably formed by partial hydrolysis of adipoyl chloride during interfacial reaction. Synthesis of 4,4′-(alkanedioyldioxy)dicinnamic acids

The procedure is as described with reference to synthesis of 4,4′-(adipoyldioxy)dicinnamic acid (Compound 2). Adipoyl dichloride (5.49 g) was dissolved in 20 mL of anhydrous THF and added dropp-wise to an ice cold solution of 14.77 g (0.09 mol) p-hydroxycinnamic acid in 80 mL of anhydrous THF and 10 mL of pyridine. The reaction mixture was stirred at room temperature for 48 h and then poured into 1 L of ice-cooled dilute hydrochloric acid (pH 2-3). The obtained precipitate was washed again with IN hydrochloric acid, then with water and acetone, and dried to yield: 10.2 g (88%) of white solid. This product recrystallized in dioxane. Melting point (m.p.) 283° C. (m.p. from the literature: 282-283° C.), (M. Nagata et al. Macromol. Biosci. (2003), 3: 412-419)

4,4′-(sebacoyldioxy)dicinnamic acid (Formula V, n=8) was recrystallized from DMF:ethanol (1:1). Yield 92%, m.p. 244.3° C., ¹H NMR,(DMSO-d₆, 500 MHz) δ: 12.34 (s, 2H, —COOH) 7.73 (d, 4H), 7.59 (d, 2H), 7.15 (d, 4H), 6.50 (d, 2H), 2.57 (t, 4H, —O—CH₂—), 1.63 (m, 4H), 1.32 (m, 8H).

Synthesized di-acids were converted into acid chlorides, applying oxalyl chloride; the general procedure is as described for diacyl chloride of 4,4′-(adipoyldioxy) dicinnamic acid, (Compound 9):

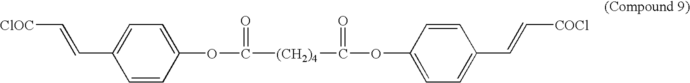

To 10 g (22.8 mmol) of Compound 2 suspended in 200 mL dry chloroform, a few drops of pyridine was added and then cooled down on an ice-bath. Using an addition funnel, 8 mL of oxalyl chloride was added drop-wise to the reaction solution and stirring was continued for 1 hour. Then the reaction mixture was-slowly heated up to reflux temperature and stirring continued for another 8 hours. The white acid suspension turned into a clear yellow solution. The reaction mixture was then filtered under nitrogen, and the filtrate was diluted with 200 mL of hexane. Yellow crystalline product formed after standing over night at room temperature. The product was filtered and dried in vacuum. Yield 9.1 g (84%). M.p.=135° C., (m.p. from the literature: 135-136° C.). (M. Nagata, et al, supra).

Diacyl chloride of 4,4′-(sebacoyldioxy)dicinnamic acid: ¹H NMR, (CDCl₃, 500 MHz) δ: 7.81 (d, 2H), 7.59 (d, 4H), 7.17 (d, 4H), 6.59 (d, 2H), 2.58 (t, 4H, —O—CH₂—), 1.78 (m, 4H), 1.40 (m, 8H).

### Synthesis of di-4-nitrophenyl esters of 4,4′-(alkanedioyldioxy)dicinnamic Acids, (Formula XIII):

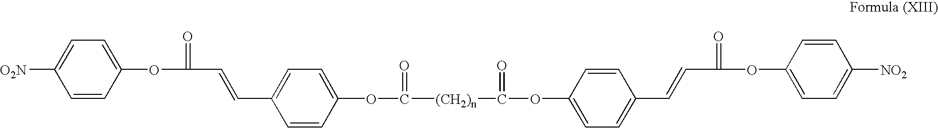

The general procedure is as follows. To the chilled (0° C.) solution of 8 g (57.5 mmol) of 4-nitrophenol and 8.1 mL of triethylamine in 100 mL of dry ethylacetate, a solution of 27.8 mmol of di-acid chloride in 150 mL of ethylacetate was added drop-wise over 30 min. Afterwards, the reaction mixture was warmed to room temperature for 8 hours and then heated to 45 ° C. for another 2 hours. Reaction mixture was concentrated by rotavaporization and the concentrate was washed with acidified 200 mL water (HCl, pH 2-3), then with deionized water, filtered and dried.

Di-(4-nitrophenyl)-ester of 4,4′-(adipoyldioxy)dicinnamic acid, (Formula XIII, n=4): Yield (65%), mp=140-143° C., (from chlorobenzene). ¹H NMR, δ (DMSO-d₆, 500 MHz): 8.33 (d, 4H), 7.93 (d, 2H), 7.89 (d, 4H), 7.53 (d, 4H), 7.25 (d; 4H), 6.91 (d, 4H, 2.68 (t, 4H), 12.77 (m, 4H).

Di-(4-nitrophenyl)-ester of 4,4′-(sebacoyldioxy)dicinnamic acid (Formula XIII, n=8): Yield ( 68%). mp 135-137° C. (from ethylacetate; soluble in acetone). ¹H NMR, (DMSO-d₆, 500 MHz), δ: 8.32 (d, 4H), 7.93 (d, 2H), 7.91 (d, 4H), 7.54 (d, 4H), 7.22 (d; 4H) 6.89 (d, 4H), 2.60 (t, 4H), 1.66 (m, 4H), 1.37 (m, 8H).

Synthesis of PEA with General Formula (XIV) 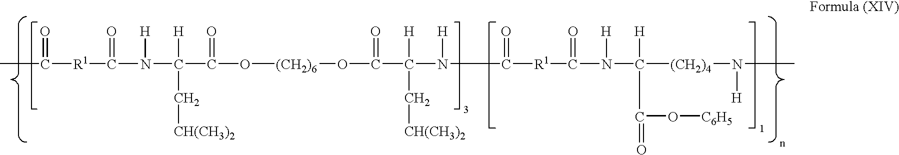
where R¹ is a combination of two acids with 1:1 feed ratios: 50% of 4,4′-(sebacoyldioxy)-dicinnamic acid (Formula V, n=8) and 50% of sebacic acid (—(CH₂)₈—).

To the stirred mixture of 9 mmol of Compound 6, 3 mmol of Compound 8, 6 mmol of compound di-(4-nitrophenyl)-ester of 4,4′-(sebacoyldioxy)dicinnamic acid (Formula XIII, n=8) and 6 mmol of bis-p-nitrophenyl sebacinate (Compound 5) in 8.5 mL of anhydrous N,N-dimethylformamide were added 12.3 mmol of triethylamine and the mixture was heated at 65° C. for 24 hours. The obtained viscous reaction solution was poured into cold water and precipitated product was filtered off and thoroughly washed with water. Crude polymer was dried and resuspended in 100 mL chloroform and p-nitrophenyl residue extracted with water several times. The organic phase was dried over sodium sulfate, filtered, concentrated by solvent evaporation. Polymer was precipitated in ethylacetate. Polymer, with average molecular weight 35 000 Da and PDI 1.51, yielded 56%. Tg 49° C.; Tensile Properties: Tensile stress at break=33.9 MPa, 2% Elongation and Young's Modulus=1129 MPa.

All publications, patents, and patent documents are incorporated by reference herein, as though individually incorporated by reference. The invention has been described with reference to various specific and preferred embodiments and techniques. However, it should be understood that many variations and modifications might be made while remaining within the spirit and scope of the invention.

Although the invention has been described with reference to the above examples, it will be understood that modifications and variations are encompassed within the spirit and scope of the invention. Accordingly, the invention is limited only by the following claims.

What is claimed is:

1. A polymer composition comprising at least one or a blend of poly(ester amide) (PEA) polymers having a chemical formula described by-general structural formula (I) 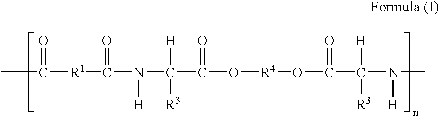
wherein, n is about 20 to about 150; each R¹ is independently selected from residues of α,ω-bis (o,m, or p-carboxyphenoxy) (C₁-C₈) alkane, 3,3′-(alkenedioyldioxy)dicinnamic acid or 4,4′-(alkanedioyldioxy)dicinnamic acid; the R³s in each n monomer are independently selected from the group consisting of hydrogen, (C₁-C₆) alkyl, (C₂-C₆) alkenyl, (C₂-C₆) alkynyl, (C₆-C₁₀) aryl (C₁-C₆) alkyl and —(CH₂)₂S(CH₂); and R⁴ is independently selected from the group consisting of (C₂-C₂₀) alkylene, (C₂-C₂₀) alkenylene, (C₂-C₈) alkyloxy, (C₂-C₂₀) alkylene, bicyclic-fragments of 1,4:3,6-dianhydrohexitols of general formula(II), and combinations thereof; 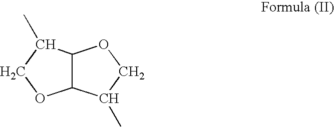
or a chemical structure described by general structural formula (III), 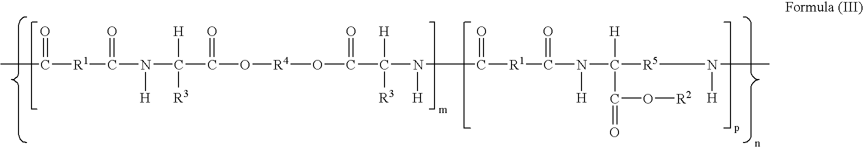
wherein m is about 0.1 to about 0.9; p is about 0.9 to about 0.1, n is about 20 to about 150, R¹ is a combination of about 0.1 part to about 0.9 part of α,ω-bis(o, m or p-carboxyphenyloxy)-(C₁-C₈) alkane, 3,3′-(alkenedioyldioxy)dicinnamic acid or 4,4′-(alkanedioyldioxy)dicinnamic acid and about 0.9 part to about 0.1 part selected from (C₂- C₂₀) alkylene, (C₂-C₂₀) alkenylene, or mixtures thereof; R² is hydrogen, or (C₆-C₁₀) aryl (C₁-C₆) alkyl or a protecting group; each R³ is independently hydrogen, (C₁-C₆) alkyl, (C₂-C₆) alkenyl, (C₂-C₆) alkynyl and (C₆-C₁₀) aryl (C₁-C₆) alkyl and —(CH₂)₂S(CH₂); each R⁴ is selected from the group consisting of (C₂-C₂₀) alkylene, (C₂-C₂₀) alkenylene, (C₂-C₈) alkyloxy (C₂-C₂₀) alkylene, bicyclic-fragments of 1,4:3,6-dianhydrohexitols of general formula III, and combinations thereof; and R⁵ is independently (C₂-C₂₀) alkyl or (C₂-C₂₀) alkylene.

2. The composition of claim 1, wherein the R³ is CH₂Ph.

3. The composition of claim 1, wherein the R³ is selected from hydrogen, CH₂—CH(CH₃)₂, CH₃, CH(CH₃)₂, CH(CH₃)CH₂—CH₃, CH₂-C₆H₅, or (CH₂)₂SCH₃.

4. The composition of claim 1, wherein all of the R³s are selected from hydrogen, CH₂—CH(CH₃)₂, CH₃, CH(CH₃)₂, CH(CH₃—CH₂—CH₃, CH₂—C₆H₅, or (CH₂)₂SCh₃.

5. The composition of claim 1, wherein at least one of the R¹s is the residues of α,ω-bis (4-carboxyphenoxy)propane.

6. The composition of claim 1, wherein at least one of the R's is the residues of α,ω-bis (4-carboxyphenoxy)hexane.

7. The composition of claim 1, wherein at least one of the R's is the residues of a,(o-bis (4-carboxyphenoxy)methane.

8. The composition of claim 1, wherein at least one of the R¹s is the residues of the 4,4′-(alkanedioyldioxy)dicinnamic acid.

9. The composition of claim 1, wherein at least one of the R¹s is the residues of the 4,4′-(adipoyldioxy)dicinnamic acid.

10. The composition of claim 1, wherein at least one of the R¹s is the residues of the 4,4′-(sebacoyldioxy)dicinnamic acid.

11. The composition of claim 1, wherein at least one of the R¹s is the residues of the 3,3′-(alkanedioyldioxy)dicinnamic acid.

12. The composition of claim 1, wherein at least one of the R¹s is the residues of the 3,3′-(adipoyldioxy)dicinnamic acid.

13. The composition of claim 1, wherein from about 0.1 part to about 0.9 part of R⁴ is the 1,4:3,6-dianhydrohexitol.

14. The composition of claim 1, wherein the 1,4:3,6-dianhydrohexitol is derived from D-glucitol, D-mannitol, or L-iditol.

15. The composition of claim 1, wherein the 1,4:3,6-dianhydrohexitol is 1,4:3,6-dianhydrosorbitol (DAS).

16. The composition of claim 1, wherein the composition biodegrades over a period of about 14 days to about six years.

17. The composition of claim 1, wherein the composition biodegrades to form from one to multiple different amino acids.

18. The composition of claim 1, wherein the polymer has a molecular weight in the range from about 15 000 Da to about 600 000 Da.

19. The composition of claim 1, wherein the polymer has a glass transition temperature (Tg) in the range from about 22° C. to about 120° C.

20. The composition of claim 1, wherein a film of the polymer has tensile stress of about 20 MPa to about 90 Mpa at yield.

21. The composition of claim 1, wherein a film of the polymer has a percent elongation of about 5% to about 400% at yield.

22. The composition of claim 1, wherein a film of the polymer has a Young's modulus in the range from about 400 MPa to about 2000 MPa at yield.

23. The composition of claim 1, wherein the composition further comprises an effective amount of at least one bioactive agent dispersed in the polymer.

24. The composition of claim 23, wherein the composition includes from about 5 to about 150 molecules of the bioactive agent per polymer molecule chain.

25. The composition of claim 23 wherein the at least one bioactive agent is covalently bonded to the polymer.

26. The composition of claim 23, wherein the at least one bioactive agent is released from the composition at a controlled rate substantially as a result of biodegradation of surface area of the composition.

27. The composition of claim 23, wherein at least two bioactive agents are dispersed in the composition.

28. The composition of claim 1, wherein the polymer has a molecular weight in the range from about 15 000 Da to about 600 000 Da.

29. A method comprising fabricating a biodegradable, biocompatible surgical device using a composition of claim 1.

30. The method of claim 29, wherein the composition further comprises a bioactive agent dispersed in the polymer.

31. The method of claim 29, wherein the surgical device biodegrades under physiological conditions over a time selected from about 14 days to about six years.

32. The composition of claim 29, wherein the surgical device is an internal fixation device.

33. The composition of claim 32, wherein the surgical device is a vascular stent or dialysis shunt.

34. A device comprising a composition of claim 1, wherein the device completely biodegrades under physiological conditions within about two days to about six years to produce substantially biocompatible breakdown products.

35. The device of claim 34, wherein the device further comprises a bioactive agent dispersed in the polymer.

36. The device of claim 34, wherein the device is an implantable internal fixation device.

37. The device of claim 35, wherein the internal fixation device is a surgical suture.

38. The device of claim 34, wherein the internal fixation device is a surgical screw.

39. The device of claim 34, wherein the internal fixation device is an implantable plate.

40. The device of claim 34, wherein the internal fixation device is an implantable rod.

41. The device of claim 34, wherein the surgical device is an implantable vascular stent.

42. The device of claim 34, wherein the device is an implantable dialysis shunt.

43. A method comprising implanting a surgical internal fixation device comprising a composition of claim 1 into an internal body site to fix the internal body site while the composition biodegrades, creating substantially biocompatible breakdown products.

44. The method of claim 41, wherein the device completely biodegrades within about two days to about six years.

45. The method of claim 41, wherein the composition further comprises a bioactive agent dispersed in the polymer and the bioactive agent is released to surrounding tissue during biodegradation of the device.
